(19) United States
(12) Patent Application Publication
(10) Pub. No.: US 2020/0118391 A1
(43) Pub. Date: Apr. 16, 2020

(54) SKILL COMPENSATED INTERACTIVE WAGERING SYSTEM

(71) Applicant: Gamblit Gaming, LLC, Glendale, CA (US)

(72) Inventors: Bryce Cire, Pasadena, CA (US); Eric Meyerhofer, Pasadena, CA (US); Frank Cire, Pasadena, CA (US)

(21) Appl. No.: 16/597,841

(22) Filed: Oct. 9, 2019

Related U.S. Application Data
(60) Provisional application No. 62/743,427, filed on Oct. 9, 2018.
(60) Provisional application No. 62/743,526, filed on Oct. 9, 2018.

(51) Int. Cl. G07F 17/32

(52) U.S. Cl. CPC G07F 17/3262; G07F 17/3288

(57) ABSTRACT

A skill compensated interactive wagering system is disclosed. The electronic gaming machine for skill compensated interactive wagering includes an interactive controller constructed to generate an interactive user interface including interactive elements, detect player interactions of a player with the interactive user interface, detect a wager commitment based on the player interactions, and determine a skill-based objective achievement state based on the player interactions. The process controller is constructed to receive the data of the wager commitment and skill-based objective achievement state from the interactive controller, in a case the skill-based objective achievement state indicates achievement of a skill-based objective, execute a wager and determine a wagering outcome for the wager using the random number generator, and in a case the skill-based objective achievement state indicates failure by the player in achieving the skill-based objective, allocate an amount of credits to an unearned win accumulator.

### CROSS REFERENCE TO RELATED APPLICATIONS

This application claims the benefit of U.S. Provisional Application No. 62/743,427 filed Oct. 9, 2018 and U.S. Provisional Application No. 62/743,526 filed Oct. 9, 2018, the contents of each of which are incorporated by reference herein.

### FIELD OF THE INVENTION

Embodiments of the invention are generally related to data processing systems. More particularly, embodiments of the invention relate to data processing systems that implement interactive wagering processes.

### BACKGROUND

The gambling industry has developed simple gambling games that are implementable on simple gaming devices and systems. For example, U.S. Pat. No. 6,905,405 to McClintic describes a simple gaming device provided with a central processor (CPU) operably coupled to controlling software memory, which includes assigned memory locations storing game software and system software. Such controlling software memory dictates when selected graphics or messages are displayed to a player, as well as when play sequences begin and end and management of wager input and award output. The CPU is also operably coupled to a second memory, which is employed to store data indicative of game statistics, number of plays, number of wins, etc. Controlling software memory, a second memory, or other, ancillary memory store data indicative of winning results, such as data representative of one or more symbol combinations, including winning combinations. Second memory may also be used, for example, to store a bit map of the symbol pattern depicted as a matrix display on video monitor. In operation of the gaming device the CPU carries out instructions of the system software to implement an initial display pattern on the video monitor and to enable the input devices. After a wager is received a player activates an initiator element such as a handle, a physical button or a touch screen to initiate a play sequence. At this point, the game software, in conjunction with a random number generator, generates a random symbol configuration at for a random final outcome comprised of a pattern of symbols for depiction on video monitor. System software then animates the video monitor by simulating the movement of visible representations of symbol carriers including symbols thereon so that the player perceives symbol carrier rotational “movement” of each symbol carrier as well as, optionally, rotational movement of the entire group of symbol carriers about a common axis. Once the visible representations of the symbol carriers have stopped, all of the generated, displayed symbols comprising a winning combination or combinations in the matrix display are identified or flagged. The displayed results (pattern of symbols depicted on the video monitor, which may include symbols received from a remote location, is compared with data stored in game software representing winning combinations to determine if any displayed combination on an active pay line is a winning combination. Any identified winning combination or combinations of symbols are then associated with winnings to be distributed to the player according to a paytable of the game software associated with the various possible winning combinations. The various pay line configurations and required combinations of the various indicia for a winning combination within each pay line reside within the game software and are retrieved for comparison to the randomly generated pattern of indicia depicted on the video monitor.

Such a simple gaming device is capable of implementing a mechanical 3-reel slot machine having 22 possible positions or symbols on each reel. In such a simple game, there are 22̂3, or 10,648, possible pays based on the combinations of the reel positions. Each time the slot machine is played, a single pay is determined from randomly spinning the mechanical reels. If a 3-reel slot machine is implemented on a simple gaming device having virtual video reels, each possible pay is explicitly enumerated in a table that is used to determine a pay as well as determine an animation sequence for the video virtual reels that corresponds to the pay. Such a table will have at least 10,648 locations, one position for each possible combination of the 3 reels, with each location representing a pay and a representation of the stopped position of the 3 reels. If digital storage of each pay requires 8 bytes of storage, the table can be stored in approximately 83 kilobytes of digital memory (8 bytes of data for each pay and reel animation identifier×10,648 possible pays/1024 Bytes per kilobyte). In operation, a single random number is determined, and that random number is used as an index into the table to select a pay and reel animation identifier from the 10,648 possible pays and reel animations. Accordingly, approximately 83 kilobytes of memory is needed to store all of the enumerated pay and reel animations of a simple slot machine game having approximately 10 thousand pay and reel animations on a simple gaming device.

Operation of another simple gaming system is described in U.S. Pat. No. 6,409,602 issued to Wiltshire et al. A game program is executed on server/host computer. It is then determined whether an image is to be displayed on a screen of a client/terminal computer. If so, an image is sent from the server/host computer to client/terminal computer. The image may include any type of graphical information including a bitmap, a JPEG file, a TIFF file or even an encoded audio/video stream such as a compressed video MPEG stream. The image is generated by game computer program and passed to server/host interface program. In turn, the image is transferred over communication pathways to client/terminal computer via the network services provided by server operating system. The image is received by a client/terminal program executing on the client/terminal computer via the network services provided by client operating system. The client/terminal program then causes the image to be displayed on a screen of the client/terminal computer. It is then determined whether an input command has been entered by the patron using the client/terminal.

In the simple gaming system, all images of the wagering game are generated on the server/host and then all of the images are transferred to the client/terminal. This limits the complexity of the interactions by the player with a wagering game hosted by the server/host because of the time required to communicate the images between the server/host and as well as network lag in requesting the transfer of the images.

Accordingly, simple gaming devices and systems are not capable of implementing complex interactive wagering processes. Various aspects and embodiments of the invention meet such a need.

### SUMMARY OF THE INVENTION

Systems and methods in accordance with embodiments of the invention generate and process interactive stochastic events within a context of an interactive application in order to implement an interactive wagering processes.

In an embodiment, a skill compensated interactive wagering electronic gaming machine includes an interactive controller constructed to receive a stochastic element of an interactive wagering process from a process controller, generate an interactive user interface using the stochastic element, detect player interactions of a player with the interactive user interface, determine a wager outcome state based on the player interactions and the stochastic element, and communicate the wager outcome state to the process controller. The skill compensated interactive wagering electronic gaming machine further includes a process controller operatively connected to the interactive controller, wherein the process controller includes a random number generator, and wherein the process controller is constructed to generate a stochastic component using the random number generator, generate the stochastic element using the stochastic component, communicate the stochastic element to the interactive controller, receive the wager outcome state from the interactive controller, and determine a wagering outcome for the interactive wagering process using the wager outcome state.

In another embodiment, a process controller operates as an interface between an interactive controller that detects player interactions and a wagering subcontroller that generates stochastic elements of an interactive wagering process. By virtue of this feature, the wagering subcontroller is isolated from the interactive controller allowing the interactive controller to operate in an unregulated environment while allowing the wagering subcontroller to operate in a regulated environment, thus providing for more efficient management of the operations of such a system.

In another embodiment of the invention, a single process controller may provide services to two or more interactive controllers, thus allowing a skill compensated interactive wagering system to operate more efficiently over a large range of scaling.

In another embodiment of the invention, multiple types of interactive controllers using different operating systems may be interfaced to a single type of process controller without requiring customization of the process controller and/or the wagering subcontroller, thus improving the efficiency of the process controller and/or the wagering subcontroller by reducing complexity associated with maintaining separate process controllers and/or wagering subcontrollers for each type of interactive controller.

In another embodiment of the invention, an interactive controller may be provided as a player device under control of a player while maintaining the process controller in an environment under the control of a regulated operator of wagering systems.

In another embodiment of the invention, data communicated between the controllers may be encrypted to increase security of the skill compensated interactive wagering system.

In another embodiment of the invention, an interactive application may require extensive processing resources from an interactive controller leaving few processing resources for the functions performed by a process controller and/or a wagering subcontroller. By virtue of an architecture of some embodiments of the invention, processing loads may be distributed across multiple devices such that operations of the interactive controller may be dedicated to an interactive application and the processes of the process controller and/or wagering subcontroller are not burdened by the requirements of the interactive application.

In another embodiment of the invention, a skill compensated interactive wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like. In many such embodiments, one or more components of a skill compensated interactive wagering system are distributed in close proximity to each other and communicate using a local area network and/or a communication bus. In several embodiments, an interactive controller and a process controller of a skill compensated interactive wagering system are in a common location. In some embodiments, a process controller communicates with an external interactive controller. In various embodiments, these multiple controllers and subcontrollers can be constructed from or configured using a single device or a plurality of devices such that a skill compensated interactive wagering system is executed as a system in a virtualized space such as, but not limited to, where a wagering subcontroller and a process controller are large scale centralized servers and are operatively connected to distributed interactive controllers via a wide area network such as the Internet or a local area network. In such embodiments, the components of a skill compensated interactive wagering system may communicate using a networking protocol or other type of device-to-device communications protocol.

In another embodiment of the invention, an interactive controller is an interactive application server acting as a host for managing head-to-head player interactions over a network of interactive subcontrollers connected to the interactive server using a communication link. The interactive server provides a distributed environment where players can compete directly with one another and interact with other players.

In an embodiment, an electronic gaming machine for skill compensated interactive wagering includes an interactive controller constructed to generate an interactive user interface including interactive elements, detect player interactions of a player with the interactive user interface, detect a wager commitment based on the player interactions, determine a skill-based objective achievement state based on the player interactions, and communicate data of the wager commitment and the skill-based achievement state to the a process controller. The process controller includes a random number generator and is constructed to receive the data of the wager commitment and skill-based objective achievement state from the interactive controller, in a case the skill-based objective achievement state indicates achievement of a skill-based objective, execute a wager and determine a wagering outcome for the wager using the random number generator, and in a case the skill-based objective achievement state indicates failure by the player in achieving the skill-based objective, allocate an amount of credits to an unearned win accumulator.

In another embodiment, interactive controller and the process controller are constructed from the same device.

In yet another embodiment, the process controller is operatively connected to the interactive controller using a communication link.

In yet another embodiment, a credit processing subcontroller and the process controller are constructed from the same device.

In yet another embodiment, a credit processing subcontroller, the interactive controller, and the process controller are constructed from the same device.

In yet another embodiment, an electronic gaming machine for skill compensated interactive wagering includes a credit processing subcontroller; and an enclosure constructed to mount a user input device operatively connected to the interactive controller, a user output device operatively connected to the interactive controller, a credit input device operatively connected to the credit processing subcontroller, and a credit output device operatively connected to the credit processing subcontroller.

In yet another embodiment, the process controller is further constructed to communicate with the credit input device to receive a credit input, credit a credit meter with credits based on the incoming credit data, update the credit meter based on the wagering outcome, and communicate with the credit output device to generate a credit output based on credits transferred off of the credit meter.

In yet another embodiment, an electronic gaming machine for skill compensated interactive wagering, includes an enclosure constructed to mount a user input device, a user output device, a credit input device, and a credit output device. The electronic gaming machine further includes a random number generator, and at least one processor operatively connected to the user input device, the user output device, the credit input device, and the credit output device, and a memory operatively connected to the at least one processor. The memory stores processor executable instructions that when executed by the processor cause the processor to communicate with the credit input device to receive a credit input, credit a credit meter with credits based on the credit data, generate an interactive user interface including interactive elements, detect player interactions of a player with the interactive user interface, detect a wager commitment based on the player interactions, determine a skill-based objective achievement state based on the player interactions, in a case the skill-based objective achievement state indicates achievement of a skill-based objective, execute a wager and determine a wagering outcome for the wager, in a case the skill-based objective achievement state indicates failure by the player in achieving the skill-based objective, allocate an amount of credits to an unearned win accumulator, update the credit meter based on the wagering outcome, and communicate with the credit output device to generate a credit output based on credits transferred off of the credit meter.

### BRIEF DESCRIPTION OF THE DRAWINGS

FIG. 1 is a state diagram of a skill compensated interactive wagering system in accordance with various embodiments of the invention.

FIG. 2 is a diagram of a structure of a skill compensated interactive wagering system in accordance with various embodiments of the invention.

FIG. 3A is a diagram of an electronic gaming machine configuration of a skill compensated interactive wagering system in accordance with various embodiments of the invention.

FIG. 3B is a diagram of a table electronic gaming machine configuration of a skill compensated interactive wagering system in accordance with various embodiments of the invention.

FIG. 3C is a diagram of a virtual reality gaming machine configuration of a skill compensated interactive wagering system in accordance with various embodiments of the invention.

FIG. 4 is a diagram of distributed skill compensated interactive wagering systems in accordance with various embodiments of the invention.

FIGS. 5A and 5B are diagrams of a structure of an interactive controller of a skill compensated interactive wagering system in accordance with various embodiments of the invention.

FIG. 6 is a diagram of a structure of a process controller of a skill compensated interactive wagering system in accordance with various embodiments of the invention.

FIG. 7 is an activity diagram of a process of a skill compensated interactive wagering system in accordance with various embodiments of the invention.

FIG. 8 is a sequence diagram of interactions between components of a skill compensated interactive wagering system in accordance with various embodiments of the invention.

FIG. 9 is an activity diagram of a process of an interactive application and a wagering user interface of a skill compensated interactive wagering system in accordance with various embodiments of the invention.

FIG. 10 is a block diagram of a process of a skill compensated interactive wagering system in accordance with an embodiment of the invention.

FIG. 11 illustrates a user interface of an interactive skill-based game of a skill compensated interactive wagering system in accordance with an embodiment of the invention.

FIG. 12 illustrates a user interface of another interactive skill-based game of a skill compensated interactive wagering system in accordance with an embodiment of the invention.

FIG. 13 illustrates a user interface of another interactive skill-based game of a skill compensated interactive wagering system in accordance with an embodiment of the invention.

FIG. 14 is an activity diagram of a process for generating an outcome selector of a skill compensated interactive wagering system having multiple volatility indexes in accordance with an embodiment of the invention.

FIG. 15 is a data flow diagram of a process for generating an outcome selector of a skill compensated interactive wagering system having multiple volatility indexes in accordance with an embodiment of the invention.

FIGS. 16A, 16B, 16C, 16D are illustrations of a user interface of another interactive skill-based game of a skill compensated interactive wagering system in accordance with an embodiment of the invention.

FIG. 17 is a state diagram of a process of a skill compensated interactive wagering system in accordance with various embodiments of the invention.

FIGS. 18A and 18B illustrate portions of a user interface of another interactive skill-based game of a skill compensated interactive wagering system in accordance with an embodiment of the invention.

FIG. 19 is another state diagram of a process of a skill compensated interactive wagering system in accordance with various embodiments of the invention.

FIGS. 20A and 20B illustrate user interfaces of another interactive skill-based game of a skill compensated interactive wagering system in accordance with an embodiment of the invention.

FIGS. 21A and 21B illustrate user interfaces of another interactive skill-based game of a skill compensated interactive wagering system in accordance with an embodiment of the invention.

### DETAILED DESCRIPTION

An interactive wagering session in accordance with various embodiments of the invention includes determining by a skill compensated interactive wagering system a wagering outcome for a wager committed by a player during one or more skill compensated interactive wagering processes.

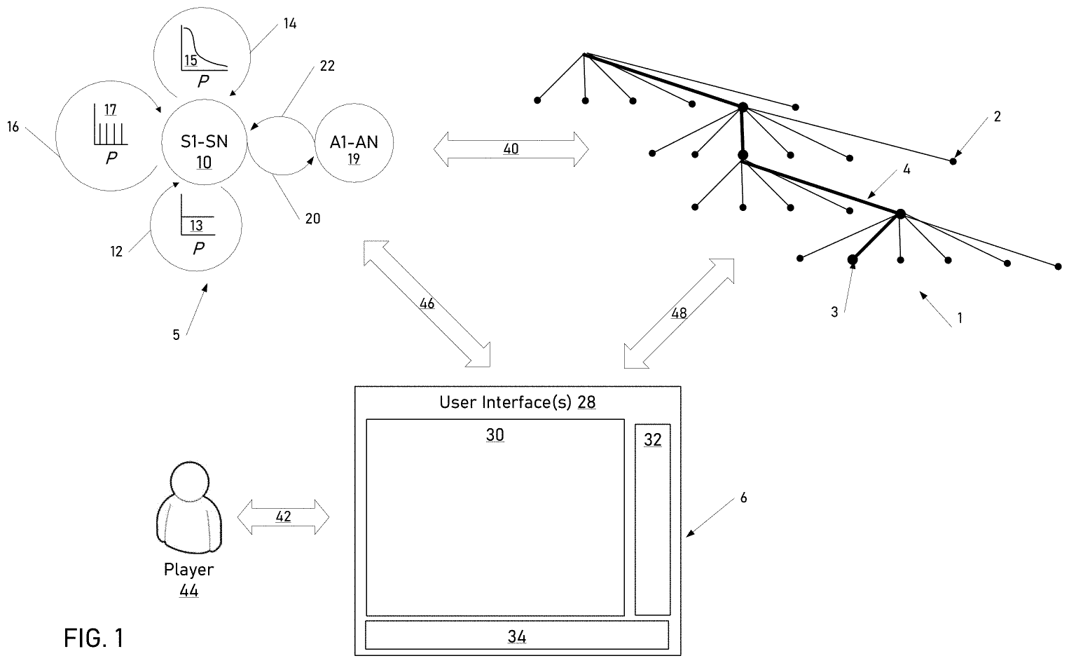

FIG. 1 illustrates a state diagram 5 of a state machine, a multidimensional process space diagram 1, and a user interface block diagram 6 of an interactive wagering system for performing an interactive wagering process in accordance with various embodiments of the invention. A multidimensional process space diagram, illustrated herein using a tree diagram 1, illustrates a process space or game space of an interactive wagering process in accordance with various embodiments of the invention. The process space of an interactive wagering process can be modeled using a multidimensional process space or manifold where each dimension of the manifold is associated with one or more variables of one or more stochastic events of an interactive wagering process. An interactive wagering process has multiple states within the multidimensional process space, herein represented by nodes in the tree diagram. Some of the nodes represent intermediate states, such as node 2, of an interactive wagering process and some of the nodes, such as node 3, represent award states representing wager outcomes of an interactive wagering process. A traversal of the multidimensional process space, such as traversal 4, can be used to model an individual wager of the interactive wagering process.

FIG. 1 also includes a state diagram 5 of a state machine of an interactive wagering system that performs an interactive wagering process in accordance with various embodiments of the invention. A traversal 4 of the interactive process space 1 of an interactive wagering process can be preformed by the state machine 5 having a set of one or more intermediate states, such as intermediate states S1 to state SN 10, and one or more award states, such as award states A1 to state AN 19. A transition between some of the states may occur in response to nondeterministic stochastic events during an interactive wagering process, such a transition is herein termed a stochastic transition. Different types and different combinations of types of stochastic events cause stochastic transitions between states of an interactive wagering process.

The set of states of the state machine are encompassed by the process space 1 of an interactive wagering process and the state machine performs a traversal 4 of the process space 1 during a wager in accordance with an interactive wagering process as indicated by double headed arrow 40.

In many embodiments, one or more stochastic transitions are made by the interactive wagering system during an interactive wagering process as a result of respective one or more stochastic events generated by an interactive wagering system, such as stochastic transition 12, where the probability that the stochastic event is generated has a probability distribution 13. A stochastic event generated by an interactive wagering system is herein termed a system stochastic event and a state associated with a system stochastic event is herein termed a system intermediate state.

In some embodiments, one or more stochastic transitions occur based on detection by an interactive wagering system of a player's interaction with an interactive wagering process, such as stochastic transition 14. The stochastic transition is based upon detection by an interactive wagering system of an interaction by a player with an interactive element of the one or more user interfaces 30 of an interactive wagering system. The probability that a player will interact with the interactive element to effect a particular stochastic transition may be described using a probability distribution 15 for the player interaction. A stochastic event resulting from detection by an interactive wagering system of a player interaction is herein termed an interactive stochastic event and intermediate state associated with detecting an interactive stochastic event is herein termed an interactive intermediate state.

In various embodiments, a stochastic transition occurs as a result of detecting a player's selection made between two or more selectable interactive elements, as exemplified by stochastic transition 16 having a discrete probability distribution 17.

An interactive wagering process may also include one or more award states, such as award states A1 to AN 19. Each award state represents an award of value awarded to a player. When an interactive wagering process transitions 20 to an award state an award is awarded to a player by the interactive wagering system performing the interactive wagering process. In some embodiments, an interactive wagering process transitions 22 from an award state back to an intermediate state for further interactive wager processing.

FIG. 1 also includes a block diagram 6 illustrating a user interface and display of an interactive wagering system in accordance with various embodiments of the invention. An interactive wagering system includes one or more user interfaces 28 that are used to display to a player 44 an interactive presentation generated by an interactive wagering system based on the state machine 5 (as indicated by double arrow 46) and based on the traversal 4 of the process space 1 (as indicated by double arrow 48) of an interactive wagering process performed by an interactive wagering system. The one or more user interfaces 28 are also used by an interactive wagering system to detect player interactions 42 with the interactive presentation.

The one or more user interfaces 28 include one or more interactive user interface portions 30 having a display used by an interactive wagering system to display to a player interactive objects that the player interacts with and to detect user interactions with the interactive objects during an interactive wagering process. In many embodiments, the one or more user interfaces also include one or more wagering user interface portions 34 having a display used by an interactive wagering system to display to a player a state of an interactive wagering process and detect player interactions with the wagering user interface. In many embodiments, the one or more wagering user interfaces also include one or more wager process user interface portions 32 having a display used by an interactive wagering system to display to a player a stochastic element generation process such as, but not limited to, a generation process of one or more chance-based outcomes.

By utilizing the one or more user interfaces 28 and associated displays, an interactive wagering system can integrate interactive stochastic events, system stochastic events, intermediate states, and award states of a process space of an interactive wagering process into a user interface and communicate a state of an interactive wagering process to the player all the while executing an interactive wagering process seamlessly from the player's perspective.

Some embodiments of interactive wagering processes have sets of intermediate states and award states whose sizes are many orders of magnitude larger than a set of pays of a simple slot machine game. In an example embodiment, an interactive wagering process incudes a display where selectable chance-based outcomes are displayed to a player as a set of possible award states. The display includes 9 locations with each location having twenty-two possible chance-based outcomes. Such an interactive wagering process display has 1,207,269,217,792, or over 1.2 trillion, possible award states. If 8 bytes of digital memory are used to store each award state, then a complete enumeration of all of award states, as required using simple gaming devices, would require 9.6 terabytes of memory storage. However, utilization an interactive wagering system and interactive wagering processes as described herein reduces the storage memory requirement of an interactive wagering process. This reduction in memory requirement reduces the amount of physical and/or virtual memory needed to implement an interactive wagering process, and also may reduce an amount of time needed to generate an interactive wagering process display.

In another example embodiment, an interactive wagering process has a process space with 17 dimensions and approximately 1,576,418,005,371,090,000,000, or over 1.5 sextillion possible intermediate states and award states. Enumeration and storage of the set of states for implementation of such an interactive wagering process on a simple electronic gaming machine would require over 12.6 zettabytes of addressable memory storage. Furthermore, if it took only 1 billionth of a second to enumerate each state, it would take almost 50,000 years to enumerate the complete set of states. Accordingly, some interactive wagering processes are simply not implementable using simple electronic gaming machines. However, interactive wagering processes having large sets of states may be implemented on various embodiments of an interactive wagering system.

In some embodiments, the skill compensated interactive wagering system's user interfaces and associated displays allow transparent coupling of an interactive game to wagering propositions, providing a seamless perspective to the player that they are playing an interactive game such as, but not limited to, a video game. In accordance with some embodiments, an interactive wagering system can be used to enable a wide range of interactive video games including but not limited to popular titles from arcade and home video games.

An aspect of some embodiments of interactive wagering processes is that there are stochastic transitions based on an interaction by a player with an interactive element of the skill compensated interactive wagering system that are skill-dependent, that is whether or not the stochastic transition is made is dependent upon the player's skill. If in making a mathematical model of the interactive wagering process an assumption is made that a player will be able to skillfully interact with the interactive element, yet does not, the mathematical model may be inaccurate as certain awards made to the player based on skill do not occur. Such awards are termed unearned wins.

In various embodiments of a skill compensating interactive wagering system, credit amounts of unearned wins are accumulated in an accumulator and awarded to a player as a bonus award. In some such embodiments, the bonus award is awarded as a chance-based outcome of an interactive wagering game where the chance-based outcome is generated using a paytable with a moderate to high volatility, an RTP of 1.0, and a wager amount of the summation of the unearned wins collected in the accumulator from the time of a previous bonus award was triggered to a time a current bonus award is triggered.

In various embodiments, the trigger points include interactive wagering game progress, in-game events, and a specified amount of credits accumulated in the unearned win accumulator.

In some embodiments, the unearned wins are allocated to the unearned win accumulator within a unique gaming session (cash in to cash out by a unique player).

In various embodiments, the unearned wins are allocated to the unearned win accumulator within a single game title or between different game titles played during a unique gaming session.

In some embodiments, the unearned wins are accumulated across multiple gaming sessions by different players.

In various embodiments, the unearned wins are accumulated across multiple gaming sessions by different players.

In some embodiments, the unearned wins are accumulated across multiple gaming sessions on gaming stations within a single gaming device.

In various embodiments, the unearned wins are accumulated across multiple gaming sessions and multiple gaming devices, and across multiple game sessions for a single player.

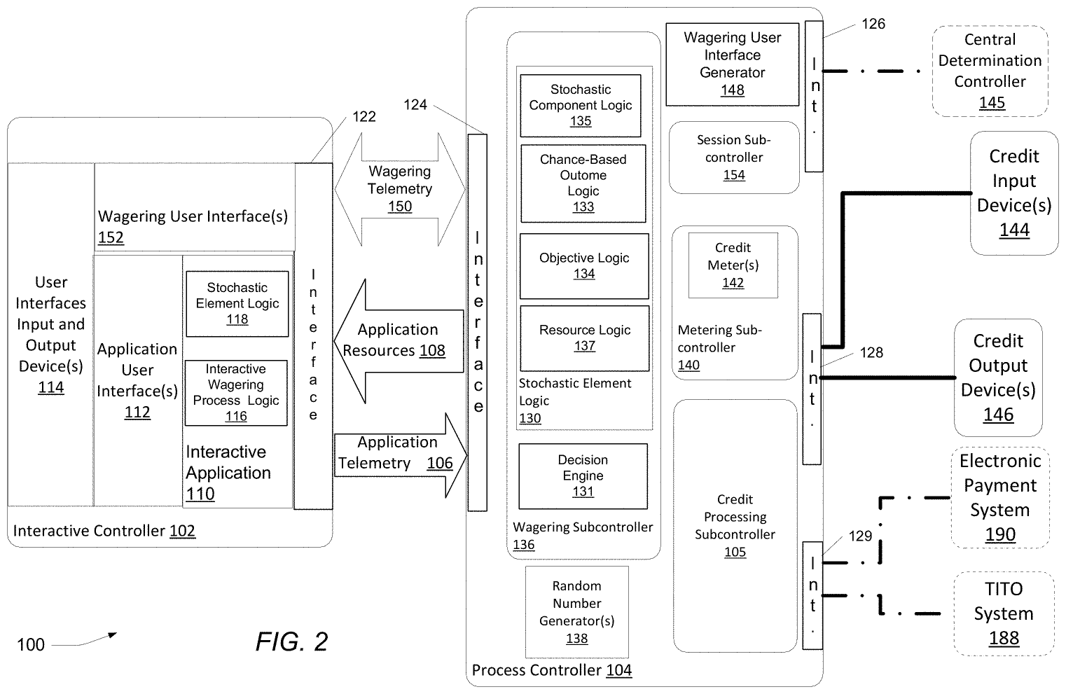

FIG. 2 is a diagram of an architecture of a skill compensated interactive wagering system in accordance with various embodiments of the invention. The skill compensated interactive wagering system is designed to implement an interactive wagering process through the generation, detection and processing of stochastic events. The skill compensated interactive wagering system 100 includes an interactive controller 102 and a process controller 104. The process controller 104 is also operatively connected to, and communicates with, various credit input and credit output devices and/or systems, such as one or more credit input devices 144, one or more credit output devices 146, a electronic payment system 190 and/or a ticket-in-ticket-out system 188, using a credit processing subcontroller 105.

In various embodiments, the interactive controller 102 detects player interactions with an interactive wagering process implemented by a skill compensated interactive wagering system. The interactive controller 102 executes an interactive application 110 and provides one or more user interface user input and output devices 114 so that one or more players can interact with the interactive application 110. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, earbuds, and the like; visual output devices such as lights, video displays and the like; and tactile devices such as rumble pads, hepatic touch screens, buttons, keys and the like. The interactive controller 102 provides for player interactions with the interactive application 110 by executing the interactive application 110 that generates an application user interface 112 that utilizes the user input devices to detect player interactions with interactive elements of the interactive application 110 of the interactive controller 102 and generates an interactive user interface that is presented to the player utilizing the user output devices.

In some embodiments, one or more components of an interactive controller are housed in an enclosure such as a housing, cabinet, casing or the like. The enclosure further includes one or more player accessible openings or surfaces constructed to mount the user input devices and/or the user output devices.

The interactive controller 102 is operatively connected to, and communicates with, the process controller 104. The interactive controller 102 receives application resource data 108 including, but not limited to, stochastic element data from the process controller 104.

In some embodiments, during execution of the interactive application 110 by the interactive controller 102, the interactive controller 102 communicates, as application telemetry data 106, detected player interactions with one or more interactive elements of the application user interfaces 112 of the interactive application, to the process controller 104. The application telemetry data 106 may include, but is not limited to, interactive application variables that indicate the state of the interactive application 110, interactive controller data indicating a status of the interactive controller 102, detected player actions and interactions between one or more players and the interactive application 110, achievement of one or more wager outcome states based on the detected player interactions with interactive elements of the interactive application 110, and utilization of interactive elements of the interactive application 110 by one or more players.

In many embodiments, the interactive application 110 includes stochastic element logic 118 utilized by the interactive application to generate one or more in-application resources and/or interactive elements in accordance with stochastic element data received from the process controller 104 included in the application resource data 108.

The interactive application 110 determines one or more wager outcome states based on detection of the interactions of the one or more players with interactive elements of the interactive application and communicates data of the determined wager outcome states to the process controller 104 as part of the application telemetry 106. In some embodiments, the interactive application 110 also communicates as part of the application telemetry data 106, data encoding the one or more players' interactions with the interactive application 110 and event data generated by the interactive application 110.

In some embodiments, the interactive application 110 is a skill-based interactive application, such as but not limited to a skill-based game. In such embodiments, during execution of the skill-based interactive application 110 by the interactive controller 102, the interactive controller 102 detects the players' skillful interaction with interactive elements of the interactive application 110 during the players' skillful interaction with the skill-based interactive application 110 to achieve an objective of the skill-based game. In such an embodiment, the process controller 104 communicates with the interactive controller 102 in order to allow the coupling of the skill-based interactive application to stochastic elements generated in accordance with an interactive wagering process implemented by the process controller 104 and/or the interactive controller 102.

In various embodiments, a skill compensated interactive wagering system can include an interactive application 110 that provides for player versus player (PvP) competitive play between a single player and a computing device, between two or more players against one another, or multiple players playing against a computing device and/or each other. In such embodiments, stochastic elements of an interactive wagering process may be interjected into the competitive play to either enhance or disrupt one or more players' competitive play of the interactive application 110.

In some embodiments, the stochastic element logic 118 is communicated to the interactive controller 102 by the process controller 104 as part of the application resource data 108.

In some embodiments, the interactive controller 102 includes one or more sensors (not shown) that sense various aspects of the physical environment of the interactive controller 102. Examples of sensors include, but are not limited to: global positioning sensors (GPSs) for sensing communications from a GPS system to detect a position or location of the interactive controller; temperature sensors; accelerometers; pressure sensors; and the like. Sensor telemetry data detected from the one or more sensors are communicated by the interactive controller to the process controller 104 as part of the application telemetry data 106. The process controller 104 receives the sensor telemetry data and uses the sensor telemetry data along with stochastic element logic 118 to generate stochastic elements of an interactive wagering process as described herein.

In many embodiments, the interactive controller 102 includes one or more wagering user interfaces 152 used to display wagering data, via one or more of the user interface input and output devices 114, to one or more players. The one or more wagering user interfaces include a presentation to one or more players of various wagering data that may include, but is not limited to, an amount of credits committed to a wager, a denomination of a wager, an amount of credits won as the result of a successful wager, and an amount of credits in a credit meter associated with the one or more players.

In various embodiments, an application control interface 122 resident in the interactive controller 102 provides an interface between the interactive controller 102 and the process controller 104 via interface 124.

In some embodiments, interfaces 122 and 124 implement an interactive controller to process controller communication protocol employing an interprocess communication protocol so that an interactive controller and a process controller may be implemented on the same device. In operation, the application control interface 122 provides application programming interfaces (APIs) that are used by an interactive application of the interactive controller to communicate outgoing data and receive incoming data by passing parameter data to another process or application.

In some embodiments, interfaces 122 and 124 implement an interactive controller to process controller communication protocol employing an interdevice communication protocol so that an interactive controller and a process controller may be implemented on different devices. The interdevice protocol may utilize a wired communication bus or wireless network as a physical layer.

In various embodiments, interfaces 122 and 124 implement an interactive controller to process controller communication protocol employing a networking protocol so that an interactive controller and a process controller may be implemented on different devices connected by a network. The networking protocol may utilize a wired communication bus or wireless network as a physical layer. In many such embodiments, the network includes a cellular telephone network or the like and the interactive controller is a mobile device such as a smartphone, tablet computer or other device capable of using the telephone network. During operation, the application control interface 122 communicates outgoing data to an external device by encoding the data into a signal and transmitting the signal to an external device. The application control interface receives incoming data from an external device by receiving a signal transmitted by the external device and decoding the signal to obtain the incoming data.

In several embodiments, interfaces 122 and 124 implement an encrypted communication protocol so that data communicated between the controllers may be encrypted to increase security of the skill compensated interactive wagering system.

In various embodiments, the process controller 104 includes a wagering subcontroller 136 that uses interactive stochastic element logic 118, and one or more random number generators 138 to generate stochastic elements used by the skill compensated interactive wagering system to perform an interactive wagering process.

In some embodiments, stochastic elements include, but are not limited to, stochastic components that are data values generated using the one or more random number generators 138 in accordance with stochastic component logic 135. In various embodiments, the stochastic components may be used in further processing by either the interactive application 110 or the process controller 104 to generate one more additional stochastic elements.

In various embodiments, stochastic elements include, but are not limited to, chance-based outcomes that are wagering outcomes of an amount of credits or other items having value as described herein. The chance-based outcomes are generated in accordance with chance-based outcome logic 133 and one or more outputs from the one or more random number generators 138.

In many embodiments, stochastic elements include, but are not limited to, objectives of the interactive wagering process that one or more players achieve when interacting with the interactive application 110 as described herein. The objectives are generated in accordance with objective logic 134 and one or more outputs from the one or more random number generators 138.

In various embodiments, stochastic elements include, but are not limited to, resources of an interactive application that a player uses and/or interacts with during interaction with the interactive application as described herein. The resources are generated in accordance with resource logic 137 and one or more outputs from the one or more random number generators 138.

In many embodiments, the wagering subcontroller 136 of the process controller 104 works in association with stochastic element logic 118 of the interactive application 110. In an example embodiment, the wagering subcontroller 136 uses an output of the one or more random number generators 138 along with the stochastic component logic 135 to generate a stochastic component. The stochastic component is then communicated to the interactive controller 102, and the interactive application uses the stochastic element logic 118 to generate one or more application resources. In other example embodiments, the wagering subcontroller 136 uses the objective logic 134 to provide a selection of an objective that is generated by the interactive application.

In several embodiments, a rule-based decision engine 131 uses the application telemetry data 106, an output of the one or more random number generators 138, along with stochastic element logic 118, to generate one or more stochastic elements as described herein. In such embodiments, a decision engine 131 includes one or more rules as part of wager processing logic 130 used by a decision engine 131 to determine how a stochastic element should be generated. Each rule includes one or more variable values constituting a pattern that is to be matched by the decision engine 131 to one or more variable values encoded in an input string of data. Each rule also includes one or more actions that are to be taken if the pattern is matched. Actions can include automatically generating one or more stochastic elements in accordance with the stochastic element logic 118 as described herein. During operation, the process controller 104 receives application telemetry data 106 from the interactive controller 102. The wagering subcontroller uses decision engine 131 to perform a matching process of matching the variable values encoded in the application telemetry data 106 to one or more variable patterns of one or more rules. If a match between the variable values and a pattern of a rule is detected, then the wagering subcontroller 136 performs the action of the matched rule.

In various embodiments, the process controller communicates data of one or more stochastic elements generated by the wagering subcontroller 136 to the interactive controller 102 as a portion of application resource data 108 communicated to the interactive controller 102.

In some embodiments, the decision engine 131 includes one or more rules as part of stochastic element logic 118 used by the decision engine to automatically generate the application resource data 108 that is then communicated to the interactive controller 102.

In some embodiments, the interactive application 110 operates utilizing a scripting language. The interactive application 110 parses scripts written in the scripting language and executes commands encoded in the scripts. In operation of such embodiments, the process controller 104 generates interactive application resource data 108 in the form of scripts written in the scripting language that are communicated to the interactive controller 102 during execution of the interactive application 110. The interactive controller 102 receives the scripts and passes them to the interactive application 110. The interactive application 110 receives the scripts, parses the scripts and automatically executes the commands as encoded in the scripts.

In many embodiments, the interactive application 110 automatically performs processes as instructed by commands communicated from the process controller 104. The commands command the interactive application 110 to perform specified operations such as executing specified commands and/or setting the values of variables utilized by the interactive application 110. In operation of such embodiments, the process controller 104 generates commands that are encoded into the application resource data 108 that are communicated to the interactive controller 102. The interactive controller 102 passes the resource data 108 to the interactive application 110. The interactive application parses the resource data and automatically performs operations in accordance with the commands encoded in the resource data 108.

In many embodiments, the process controller 104 includes one or more interfaces, such as interface 126, that operatively connect the process controller 104 to one or more external devices used to generate chance-based outcomes, such as central determination controller 145. In operation, when a wagering subcontroller 136 of the process controller 104 needs a chance-based outcome, the wagering subcontroller communicates a request to the central determination controller 145 for the chance-based outcome. The central determination controller 145 receives the chance-based outcome request and generates a chance-based outcome in response to the chance-based outcome request. The central determination controller communicates data of the chance-based outcome to the process controller 104. The process controller 104 receives the data of the chance-based outcome and utilizes the chance-based outcome as described herein. In some embodiments, the chance-based outcome is drawn from a pool of pre-generated chance-based outcomes.

In various embodiments, the central determination controller 145 is a progressive controller that is operatively connected to a plurality of skill compensated interactive wagering systems (not shown). The progressive controller provides services for the collection and provision of credits used by the process controller 104 to provide wagering outcomes that have a progressive or pooling component.

In some embodiments, the process controller 104 includes one or more interfaces, such as interface 128, that operatively connect the process controller 104 to one or more credit input devices, such as credit input devices 144, and to one or more credit output devices, such as credit output devices 146.

In various embodiments, the process controller 104 includes one or more interfaces, such as interface 129, that operatively connect the process controller 104 to one or more ticket-in-ticket-out systems 188 and/or one or more electronic payment systems 190.

The process controller 104 manages one or more wagers in accordance with one or more interactive wagering processes implemented by the skill compensated interactive wagering system 100 by determining a commitment of a wager of value to the interactive wagering process, executing the interactive wagering process, and determining a wagering outcome of value of the interactive wagering process. Types of value committed to the one or more wagers can be one or more of several different types. In various embodiments, types of value of a wager can include, but are not limited to, a wager of an amount of credits corresponding to a real currency or a virtual currency, a wager of an amount of application credits earned through interaction with an interactive application, a wager of an amount of interactive elements of an interactive application, and/or a wager of an amount of objects used in an interactive application. In various embodiments, a type of value of a wagering outcome for a wager committed to a wagering process can be one or more of several different types. In various embodiments, types of value of a wagering outcome can include, but are not limited to, a wagering outcome of an amount of credits corresponding to a real currency or a virtual currency, a wagering outcome of an amount of application credits earned through interaction with an interactive application, a wagering outcome of an amount of interactive elements of an interactive application, and a wagering outcome of an amount of in-application objects used in an interactive application.

In various embodiments, a type of value of a wagering outcome of an interactive wagering process is different than a type of value of a wager commitment of the interactive wagering process. In an example embodiment, a value of a wager commitment can be an amount of credits, and a value of a wagering outcome can be an in-application object of an interactive application.

In many embodiments, the process controller 104 includes one or more random number generators (RNGs) having a known stochastic behavior 138 for generating non-deterministic random numbers having a known probability distribution. The wagering subcontroller 136 uses outputs from the one or more random number generators 138 along with the stochastic element logic 118 to generate one or more stochastic elements as described herein.

In many embodiments, the one or more random number generators 138 generate random numbers by continuously generating pseudorandom numbers using one or more pseudorandom number generators. A most current pseudorandom number is stored in a buffer thus constantly refreshing the buffer. In many embodiments, the buffer is refreshed at a rate of approximately 100 times per second. When the wagering subcontroller 136 requests a random number to be used to generate a stochastic element, a random number generator outputs the stored most current pseudorandom number from the buffer. As timing between the requests for a random number is non-deterministic, the resulting output from the buffer is a true non-deterministic random number. In some embodiments, a random number generator includes a plurality of pseudorandom number generators that generate and store pseudorandom numbers into a respective plurality of buffers wherein each of the pseudorandom number generators is seeded with a different seed. When a request is made to generate a random number, the random number generator generates an additional pseudorandom number and on the basis of the additional pseudorandom number, randomly selects a respective buffer to output the requested random number. In some embodiments, a respective buffer is randomly chosen by hashing a value from a realtime clock circuit to create a randomized index value that is then used to select from between the respective buffers.

In some embodiments, a stochastic component is generated by a skill compensated interactive wagering system by executing stochastic component generation instructions included in stochastic component logic to generate a stochastic component from one or more random numbers output from one or more random number generators. In various embodiments, the stochastic component is a random number. In some such embodiments, the stochastic component is a hash of a random number output by a random number generator in order to reduce the range of values of the random number so that the stochastic component can be used as an index into a lookup table.

In some embodiments, an objective is generated by a skill compensated interactive wagering system by executing objective generation commands included in objective logic that define processes of an interactive wagering process where the objective generation commands are formatted in a scripting language. In operation, a decision engine of a process controller generates the objective generation commands in the form of a script written in the scripting language. The script includes the objective generation commands that describe how the wagering subcontroller is to generate data of an objective. The wagering subcontroller parses the script encoded in the objective generation command data and executes the commands included in the script to generate data of the objective.

In some embodiments, an objective is generated by a skill compensated interactive wagering system by executing objective generation commands included in objective logic to generate a stochastic component and use the stochastic component as in index into a lookup table having stored data of a plurality of objectives.

In some embodiments, an objective is generated by a skill compensated interactive wagering system by executing objective generation instructions included in objective logic to generate a stochastic component and use the stochastic component in one or more conditional statements of the objective generation instructions to control generation of data of one or more objectives.

In some embodiments, a chance-based outcome is generated by a skill compensated interactive wagering system by executing chance-based outcome generation commands included in chance-based outcome logic to generate a stochastic component and use the stochastic component as in index into a lookup table having stored data of a plurality of chance-based outcomes.

In various embodiments, a process controller uses a rule-based decision engine to automatically generate an amount of application credits to award to a player based at least in part on application telemetry data including wager outcome state data and player interaction data with an interactive application of the skill compensated interactive wagering system. In numerous embodiments, the interactive application is a skill-based interactive application and the application credits are awarded for a player's skillful interaction with the interactive application.

In several embodiments, the process controller 104 includes a metering subcontroller 140. The metering subcontroller 140 communicates with the credit processing subcontroller 105 to receive incoming credit data from the credit processing subcontroller 105. The metering subcontroller 140 uses the incoming credit data to transfer credits into the skill compensated interactive wagering system and onto one or more credit meters 142 associated with one or more players. The metering subcontroller 140 communicates outgoing credit data to the credit processing subcontroller 105 to transfer credits off of the one or more credit meters 142 and out of the skill compensated interactive wagering system.

In various embodiments, the credit process subcontroller 105 and metering subcontroller 140 process types of value committed to the one or more wagers other than credits. In such embodiments, the types of value can be one or more of several different types including, but not limited to, credits corresponding to a real currency or a virtual currency, application credits earned through interaction with an interactive application, interactive elements of an interactive application, and/or objects used in an interactive application.

In some embodiments, the wagering subcontroller 136 uses a wagering user interface generator 148 to automatically generate wagering telemetry data 150 on the basis of amounts of credits on the one or more credit meters 142. The wagering telemetry data 150 is used by the process controller 104 to command the interactive controller 102 to automatically generate one or more wagering user interfaces 152 describing a state of wagered credit accumulation and loss for the skill compensated interactive wagering system. When a player interacts with the one or more wagering user interfaces 152, wagering user interface telemetry data 150 is generated by the one or more wagering user interfaces 152 and communicated by the interactive controller 102 to the process controller 104 using interfaces 122 and 124.

In some embodiments, the wagering telemetry data 150 may include, but is not limited to, amounts of application credits and interactive elements earned, lost or accumulated through interaction with the interactive application 110, and credits, application credits and interactive elements amounts won, lost or accumulated.

In some embodiments, the resource data 108 are communicated to the wagering user interface generator 148 and used as a partial basis for generation of the wagering telemetry data 150 communicated to the interactive controller 102.

In various embodiments, the wagering user interface generator 148 also receives interactive wagering process state data that is used as a partial basis for generation of the wagering telemetry data 150 communicated to the interactive controller 102. In some embodiments, the interactive wagering process state data includes stochastic element data generated by the wagering subcontroller 136 during the generation of stochastic elements. In various such embodiments, the wagering user interface generator 148 generates a stochastic element generation display using the one or more states of the interactive wagering process. The stochastic element generation display is included in the wagering telemetry data 150 that is communicated to the interactive controller 102. The stochastic element generation display is automatically displayed by the interactive controller 102 using the one or more wagering user interfaces 152. In other such embodiments, the interactive wagering process state data are communicated to the interactive controller 102 and the interactive controller 102 is instructed to automatically generate the stochastic element generation display of the one or more wagering user interfaces 152.

In some embodiments, the interactive wagering process state data includes, but is not limited to, a final state, an intermediate state, a beginning state, and/or a wager outcome state of the interactive wagering process. For example, in an interactive wagering process that is based on slot machine math, the final state of the interactive wagering process may be reel positions, in an interactive wagering process that is based on roulette wheel math, the final state may be a pocket where a ball may have come to rest, in an interactive wagering process that is a based on card math, the beginning, intermediate and final states may represent a sequence of cards being drawn from a deck of cards, etc.

In some embodiments, an interactive controller generates a wagering user interface by executing commands that define processes of the wagering user interface where the commands are formatted in a scripting language. In operation, a wagering user interface generator of a process controller generates commands in the form of a script written in the scripting language. The script includes commands that describe how the interactive controller is to display interactive wagering process state data. The completed script is encoded as wagering telemetry data and communicated to the interactive controller by the process controller. The interactive controller receives the wagering telemetry data and parses the script encoded in the wagering telemetry data and executes the commands included in the script to generate the wagering user interface.

In many embodiments, an interactive controller generates a wagering user interface based on a document written in a document markup language that includes commands that define processes of the wagering user interface. In operation, a wagering user interface generator of a process controller generates a document composed in the document markup language. The document includes commands that describe how the interactive controller is to display interactive wagering process state data. The completed document is encoded as wagering telemetry data and communicated to the interactive controller by the process controller. The interactive controller receives the wagering telemetry data and parses the document encoded in the wagering telemetry data and executes the commands encoded into the document to generate the wagering user interface.

In some embodiments, an interactive controller generates a wagering user interface by executing commands that define processes of the wagering user interface. In operation, a wagering user interface generator of a process controller generates the commands and encodes the commands into wagering telemetry data that is communicated to the interactive controller by the process controller. The interactive controller receives the wagering telemetry data and executes the commands encoded in the wagering telemetry data to generate the wagering user interface.

In various embodiments, an interactive controller includes a data store of graphic and audio display resources that the interactive controller uses to generate a wagering user interface as described herein.

In many embodiments, a process controller communicates graphic and audio display resources as part of wagering telemetry data to an interactive controller. The interactive controller uses the graphic and audio display resources to generate a wagering user interface as described herein.

In various embodiments, the wagering user interface generator 148 processes various types of value committed to one or more wagers. In such embodiments, the types of value can be one or more of several different types including, but not limited to, credits corresponding to a real currency or a virtual currency, application credits earned through interaction with an interactive application, interactive elements of an interactive application, and/or objects used in an interactive application.

In some embodiments, the process controller 104 utilizes the one or more wagering user interfaces 152 to communicate certain interactive application data to the player, including but not limited to, club points, player status, control of the selection of choices, and messages which a player can find useful in order to adjust the interactive application experience or understand the wagering status of the player.

In some embodiments, the process controller 104 utilizes the one or more wagering user interfaces 152 to communicate aspects of an interactive wagering process to a player including, but not limited to, amount of credits, application credits, interactive elements, or objects in play, and amounts of credits, application credits, interactive elements, or objects available.

In a number of embodiments, the wagering subcontroller 136 can accept interactive wagering process factors including, but not limited to, modifications in the amount of credits, application credits, interactive elements, or objects wagered on each individual wagering event, entrance into a bonus round, and other factors. In several embodiments, the process controller 104 can communicate a number of factors back and forth to the wagering subcontroller, such that an increase/decrease in a wagered amount can be related to the change in player profile of the player in the interactive application. In this manner, a player can control a wager amount per wagering event in accordance with the interactive wagering process with the change mapping to a parameter or component that is applicable to the interactive application experience.

In some embodiments, the process controller 104 includes a session subcontroller 154 is used to regulate a skill compensated interactive wagering system session. In various embodiments, components of the process controller 104 communicate session data to the session subcontroller 154. The session data may include, but is not limited to, player data, interactive controller data, pooled bet and side bet data, process controller data and wagering subcontroller data used by the session subcontroller to regulate a skill compensated interactive wagering system session.

In some embodiments, the session subcontroller 154 may also assert control of a skill compensated interactive wagering system session by communicating session control data to components of the process controller 104. Such control may include, but is not limited to, commanding the process controller 104 to end a skill compensated interactive wagering system session, initiating wagering in a skill compensated interactive wagering system session, ending wagering in a skill compensated interactive wagering system session but not ending a player's use of the interactive application portion of the skill compensated interactive wagering system, and changing from real credit wagering in a skill compensated interactive wagering system to virtual credit wagering, or vice versa.

In many embodiments, the session subcontroller 154 manages player profiles for a plurality of players. The session subcontroller 154 stores and manages data about players in order to provide authentication and authorization of players of the skill compensated interactive wagering system 100. In some embodiments, the session subcontroller 154 also manages geolocation information to ensure that the skill compensated interactive wagering system 100 is only used by players in jurisdictions were wagering is approved. In various embodiments, the session subcontroller 154 stores application credits that are associated with the player's use of the interactive application of the skill compensated interactive wagering system 100.

In some embodiments, the session subcontroller 154 communicates player and session management data to the player using a management user interface (not shown) of the interactive controller. The player interacts with the management user interface and the management user interface generates management telemetry data that is communicated to the session subcontroller 154.

In some embodiments, the wagering subcontroller 136 communicates wagering session data to the session subcontroller 154. In various embodiments, the session subcontroller communicates wagering session control data to the wagering subcontroller 136.

In many embodiments, the credit processing subcontroller 105 operatively connects to one or more credit input devices for generating incoming credit data from a credit input. Credit inputs can include, but are not limited to, credit items used to transfer credits. The incoming credit data are communicated by the credit processing subcontroller 105 to the metering subcontroller 140. In various embodiments, the one or more credit input devices and their corresponding credit items include, but are not limited to: card readers for reading cards having magnetic stripes, RFID chips, smart chips, and the like; scanners for reading various types of printed indicia printed on to various types of media such as vouchers, coupons, TITO tickets, rewritable cards, or the like; and bill validator and/or coin validators that receive and validate paper and/or coin currency or tokens.

In various embodiments, the credit processing subcontroller 105 includes one or more credit output devices 146 for generating a credit output based on outgoing credit data 192 communicated from the wagering subcontroller. Credit outputs can include, but are not limited to, credit items used to transfer credits. Types of credit output devices and their corresponding credit items may include, but are not limited to: writing devices that are used to write to cards having magnetic stripes, smart chips or the like; printers for printing various types of printed indicia onto vouchers, coupons, TITO tickets, vouchers, rewritable cards or the like; and bill and/or coin dispensers that output paper and/or coin currency or tokens.

In some embodiments, the credit processing subcontroller 105 is operatively connected to, and communicates with, a TITO system 188 or the like to determine incoming credit data representing amounts of credits to be transferred into the skill compensated interactive wagering system and to determine outgoing credit data representing amounts of credits to be transferred out of the skill compensated interactive wagering system. In operation, the credit processing subcontroller 105 communicates with a connected credit input device, such as a bill validator/ticket scanner, used to scan a credit input in the form of a TITO ticket having indicia of credit account data of a credit account of the TITO system. The credit processing subcontroller 105 communicates the credit account data to the TITO system. The TITO system uses the credit account data to determine an amount of credits to transfer to the credit processing subcontroller 105, and thus to the metering subcontroller 140 of the process controller 104. The TITO system communicates the amount of credits to the credit processing subcontroller 105. The credit processing subcontroller 105 communicates the amount of credits as incoming credit data to the metering subcontroller 140 and the metering subcontroller 140 credits one or more credit meters 142 with the amount of credits so that the credits can be used when a player makes wagers using the skill compensated interactive wagering system 100.

In many embodiments, the credit processing subcontroller 105 is operatively connected to a bill validator/ticket scanner as one of the one or more credit input devices 144. The credit processing subcontroller 105 communicates with the bill validator/ticket scanner to scan currency used as a credit input to determine an amount of credits as incoming credit data to transfer credit to one or more credit meters 110 associated with one or more players. The skill metering subcontroller 140 credits the one or more credit meters 110 with the amount of credits so that the credits can be used when a player makes wagers using the skill compensated interactive wagering system 100.

In some embodiments, the credit processing subcontroller 105 can use a TITO system along with a ticket or voucher printer as one of the one or more credit output devices 146 to generate a TITO ticket as a credit output for a player. In operation, the credit processing subcontroller 105 communicates, as outgoing credit data, data of an amount of credits to be credited to a credit account on the TITO system. The TITO system receives the amount of credits and creates the credit account and credits the credit account with the amount of credits. The TITO system generates credit account data for the credit account and communicates the credit account data to the credit processing subcontroller 105. The credit processing subcontroller 105 uses the ticket or voucher printer to print indicia of the credit account data onto a TITO ticket or voucher as a credit output.

In various embodiments, a credit processing interface 156 resident in the credit processing subcontroller 105 provides an interface between the credit processing subcontroller 156 and the process controller 104.

In some embodiments, the credit processing interface 156 implements a credit processing subcontroller to process controller communication protocol employing an interprocess communication protocol so that the process controller 104 and the credit processing subcontroller 105 may be implemented on the same device. In operation, the credit processing interface 156 provides application programming interfaces that are used by the credit processing subcontroller 105 to communicate outgoing data and receive incoming data by passing parameter data to another process or application.

In some embodiments, the credit processing interface 156 implements process controller to credit processing subcontroller communication protocol employing an interdevice communication protocol so that the process controller and the credit processing subcontroller may be implemented on different devices. The interdevice protocol may utilize a wired communication bus or wireless network as a physical layer.

In various embodiments, the credit processing interface 156 implements a process controller to credit processing subcontroller communication protocol employing a networking protocol so that the process controller 104 and the credit processing subcontroller 105 may be implemented on different devices connected by a network. The networking protocol may utilize a wired communication bus or wireless network as a physical layer. During operation, the credit processing interface 156 communicates outgoing data to an external device by encoding the data into a signal and transmitting the signal to an external device. The application control interface receives incoming data from an external device by receiving a signal transmitted by the external device and decoding the signal to obtain the incoming data.

In various embodiments, the credit processing subcontroller 105 provides an interface to an electronic payment management system 190 such as an electronic wallet or the like. The electronic payment system provides credit account data that is used for generating incoming credit data as a credit input and outgoing credit data as a credit output.

In several embodiments, during operation, the metering subcontroller 140 communicates with the credit processing subcontroller 105 to receive incoming credit data from the credit processing subcontroller 105 and adds credits onto the one or more credit meters 110 at least partially on the basis of the incoming credit data. The wagering subcontroller 136 uses the interactive stochastic element logic 118 and outputs from the one or more random number generators 138 to generate one or more stochastic elements. Data of the one or more stochastic elements are communicated by the process controller 104, as part of the application resource and resource data 108, to the interactive controller 102. The interactive application 110 uses the stochastic element data to generate an interactive user interface for the user including the one or more application user interfaces 112. One or more players interact with the one or more application user interfaces 112 through the one or more user interface input and output devices 114. The interactive application 110 detects the player interactions and determines a wager outcome state based on the detected interactions of the one or more players using the interactive wagering process logic 116 and communicates data of the wager outcome state as part of the application telemetry data 106 to the process controller 104. The wagering subcontroller 136 receives the wager outcome state data and determines a wagering outcome based on the wager outcome state data, and instructs the metering subcontroller 140 to add credits to, or deduct credits from, the one or more credit meters 110 based in part on the wagering outcome data. For example, in some embodiments, the metering subcontroller is instructed to add an amount of credits to a credit meter of the one or more credit meters 110 when the wagering outcome indicates a win for a player associated with the credit meter. In various embodiments, the metering subcontroller is instructed to deduct an amount of credits from the credit meter when the wagering outcome data indicates a loss for the player. At an end of a wagering session, the metering subcontroller 140 transfers credits off of the one or more credit meters 110 and out of the skill compensated interactive wagering system by communicating outgoing credit data to the credit processing subcontroller 105. The credit processing subcontroller 105 uses the outgoing credit data to generate one or more credit output items using the one or more credit output devices 146.

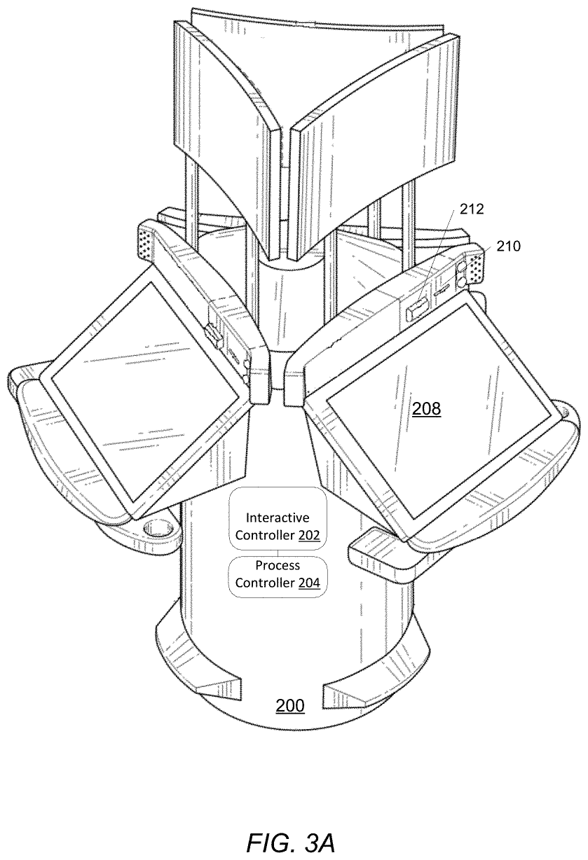

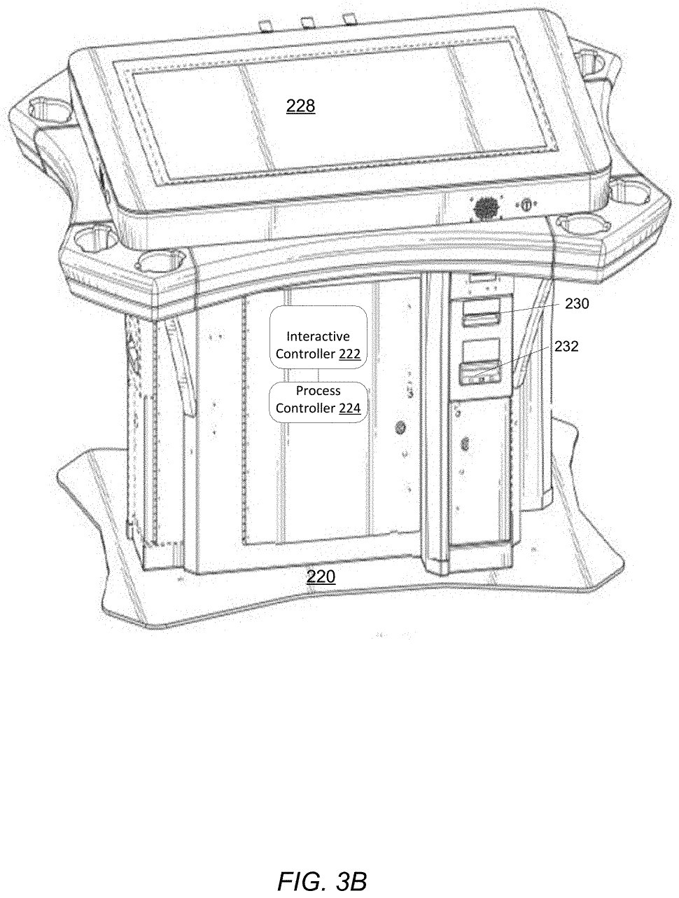

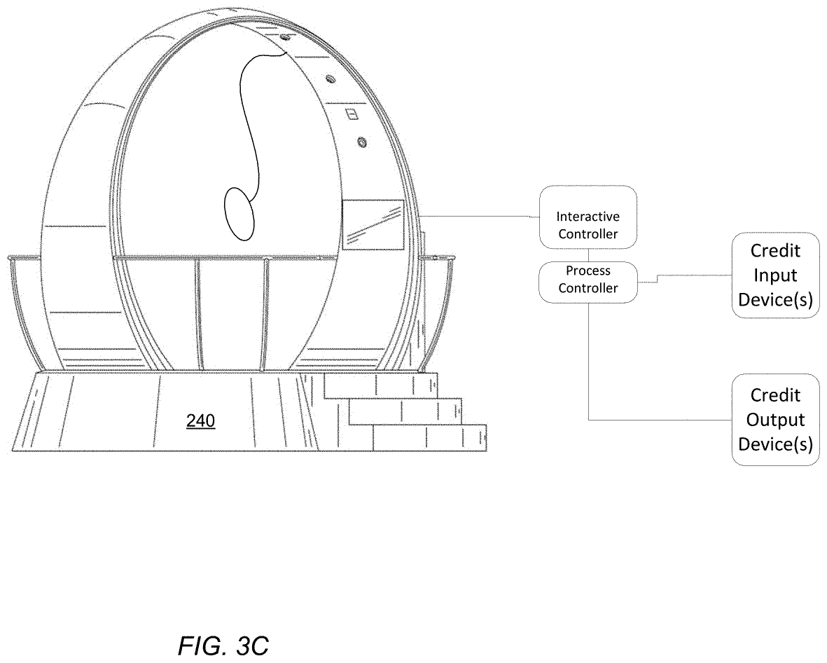

FIG. 3A is a diagram of an electronic gaming machine configuration of a skill compensated interactive wagering system in accordance with various embodiments of the invention. Electronic gaming machine configurations of a skill compensated interactive wagering system include, but are not limited to, electronic gaming machines such as slot machines, table games, video arcade consoles and the like. An electronic gaming machine configuration of a skill compensated interactive wagering system 200 includes an interactive controller 202 as described herein and a process controller 204 as described herein contained in an enclosure such as a housing, cabinet, casing or the like. The enclosure may further include one or more player accessible openings or surfaces that may be used to mount one or more player accessible user input devices and user output devices 208 as described herein, one or more player accessible credit input devices 210 and one or more player accessible credit output devices 212 as described herein. The interactive controller 202 communicates with the user input devices to detect player interactions with the skill compensated interactive wagering system and commands and controls the user output devices to provide a user interface to one or more players of the skill compensated interactive wagering system as described herein. The process controller 204 communicates using a credit processing subcontroller to one or more player credit processing devices, such as credit input device 210 and credit output device 212 to transfer credits into and out of the skill compensated interactive wagering system as described herein.

In various embodiments, the process controller 204 uses a credit processing subcontroller operatively connected to one or more credit input devices 210 for generating incoming credit data from a credit input as described herein.

In various embodiments, the credit processing subcontroller is operatively connected to the one or more credit output devices 212 for generating a credit output based on outgoing credit data communicated from the process controller 204 as described herein.

In some embodiments, the credit processing subcontroller is operatively connected to, and communicates with, a TITO system (not shown) or the like to determine incoming credit data representing amounts of credits to be transferred into the skill compensated interactive wagering system 200 and to generate outgoing credit data representing amounts of credits to be transferred out of the skill compensated interactive wagering system 200 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the process controller 204 is operatively connected to a central determination controller (not shown) as described herein.

In various embodiments, the process controller 204 may be operatively connected to a progressive controller along (not shown) with one or more other process controllers of one or more other skill compensated interactive wagering systems as described herein.

FIG. 3B is a diagram of multiplayer or multiplayer electronic gaming machine configuration of a skill compensated interactive wagering system in accordance with various embodiments of the invention. Types of a multiplayer or multiplayer electronic gaming machine configuration a skill compensated interactive wagering system include, but are not limited to, multiplayer or multiplayer electronic gaming machines, multiplayer or multiplayer slot machines, multiplayer or multiplayer table gaming devices, multiplayer or multiplayer video arcade consoles and the like. A multiplayer or multiplayer electronic gaming machine configuration of a skill compensated interactive wagering system 220 includes an interactive controller 222 as described herein and a process controller 224 as described herein contained in an enclosure such as a housing, cabinet, casing or the like. The enclosure may further include one or more player accessible openings or surfaces that may be used to mount one or more player accessible user input devices and user output devices 228 as described herein, one or more player accessible credit input devices 230 as described herein and one or more player accessible credit output devices 232 as described herein.

In some embodiments, two or more sets of credit input devices and credit output devices are provided so that each player of the multiplayer or multiplayer electronic gaming machine configuration of a skill compensated interactive wagering system 220 can have an associated set of credit input devices and credit output devices.

The interactive controller 222 communicates with the user input devices to detect player interactions with the skill compensated interactive wagering system and commands and controls the user output devices to provide a user interface to one or more players of the skill compensated interactive wagering system as described herein. The process controller 224 communicates with the credit processing subcontroller 226 or player credit processing devices 230 and 232 to transfer credits into and out of the skill compensated interactive wagering system as described herein.

In various embodiments, the process controller 224 uses a credit processing subcontroller operatively connected to one or more credit input devices 230 for generating incoming credit data from a credit input as described herein.

In various embodiments, the credit processing subcontroller is operatively connected to the one or more credit output devices 232 for generating a credit output based on outgoing credit data communicated from the process controller 224 as described herein.

In some embodiments, the credit processing subcontroller is operatively connected to, and communicates with, a TITO system (not shown) or the like to determine incoming credit data representing amounts of credits to be transferred into the skill compensated interactive wagering system 220 and to generate outgoing credit data representing amounts of credits to be transferred out of the skill compensated interactive wagering system 220 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the process controller 224 is operatively connected to a central determination controller (not shown) as described herein.

In various embodiments, the process controller 224 may be operatively connected to a progressive controller along (not shown) with one or more other process controllers of one or more other skill compensated interactive wagering systems as described herein.

FIG. 3C is a diagram of virtual reality gaming machine configuration of a skill compensated interactive wagering system in accordance with various embodiments of the invention. Types of a virtual reality gaming machine configuration of a skill compensated interactive wagering system include, but are not limited to, virtual reality gaming machines, virtual reality slot machines, virtual reality gaming devices, virtual reality arcade consoles and the like. A virtual reality gaming machine 240 configuration of a skill compensated interactive wagering system includes an interactive controller, a process controller and a credit processing subcontroller contained in an enclosure such as a housing, cabinet, casing or the like. The enclosure may further include one or more player accessible openings or surfaces that may be used to mount one or more player accessible user input devices and user output devices, one or more player accessible credit input devices and one or more player accessible credit output devices.

A virtual reality gaming machine configuration of a skill compensated interactive wagering system further includes a player area having virtual reality sensors for sensing player interactions and/or player movements within the player area, a player headset having a stereoscopic visual display for presentation of a stereoscopic interactive user interface to a player, headphones for presenting a stereophonic sound presentation to a player, and one or more subwoofers for providing a hepatic or low frequency auditory presentation to the player.

The interactive controller communicates with the user input devices to detect player interactions with the virtual reality skill compensated interactive wagering system and commands and controls the user output devices to provide a user interface to one or more players of the virtual reality skill compensated interactive wagering system as described herein. The process controller communicates with the credit processing subcontroller or player credit processing devices and to transfer credits into and out of the skill compensated interactive wagering system as described herein.

In many embodiments, the process controller is further connected to one or more side betting terminals that enable spectators of a player using the virtual reality skill compensated interactive wagering system to make side bets based on the performance of the player.

In various embodiments, the process controller 224 uses a credit processing subcontroller operatively connected to one or more credit input devices 230 for generating incoming credit data from a credit input as described herein.

In various embodiments, the credit processing subcontroller is operatively connected to the one or more credit output devices 232 for generating a credit output based on outgoing credit data communicated from the process controller 224 as described herein.

In some embodiments, the credit processing subcontroller is operatively connected to, and communicates with, a TITO system (not shown) or the like to determine incoming credit data representing amounts of credits to be transferred into the skill compensated interactive wagering system 220 and to generate outgoing credit data representing amounts of credits to be transferred out of the skill compensated interactive wagering system 220 as described herein.

In various embodiments, the credit processing subcontroller provides an interface to an electronic payment system (not shown) such an electronic wallet or the like. The electronic payment system provides credit account data that is used for generating incoming credit data as a credit input and outgoing credit data as a credit output as described herein.

In some embodiments, the process controller 224 is operatively connected to a central determination controller (not shown) as described herein.

In various embodiments, the process controller 224 may be operatively connected to a progressive controller along (not shown) with one or more other process controllers of one or more other skill compensated interactive wagering systems as described herein.

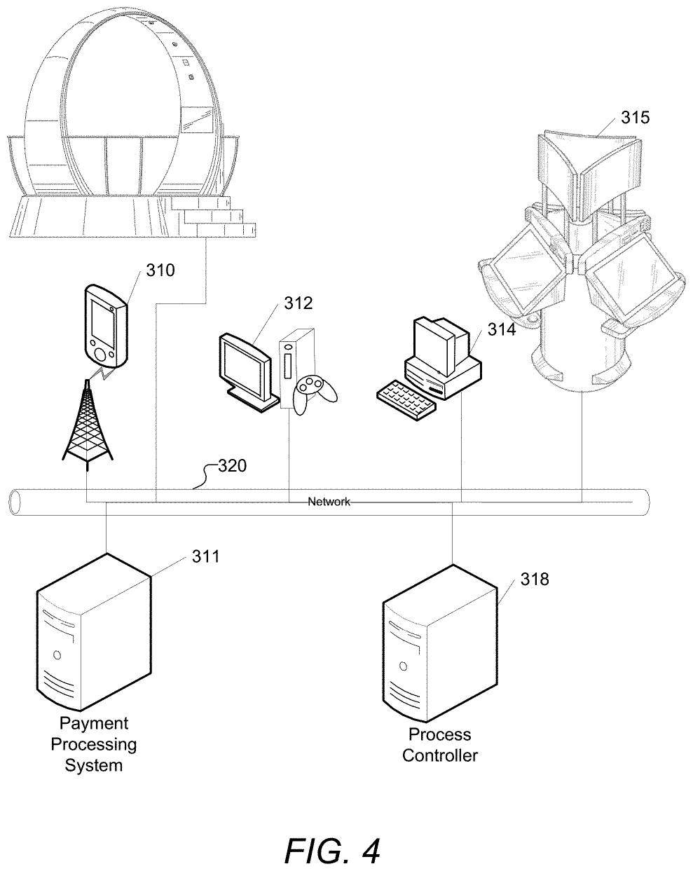

FIG. 4 is a diagram of distributed skill compensated interactive wagering systems in accordance with various embodiments of the invention. An interactive controller, such as interactive controller 102 of FIG. 2, may be constructed from or configured using one or more processing devices that perform the operations of the interactive controller. An interactive controller in a distributed skill compensated interactive wagering system may be constructed from or configured using any processing device having sufficient processing and communication capabilities to perform the processes of an interactive controller in accordance with various embodiments of the invention. In some embodiments, the construction or configuration of the interactive controller may be achieved through the use of an application control interface, such as application control interface 122 of FIG. 2, and/or through the use of an interactive application, such as interactive application 110 of FIG. 2.

In various embodiments, an interactive application may require extensive processing resources from an interactive controller leaving few processing resources for the functions performed by a process controller and/or a wagering subcontroller. By virtue of the architecture described herein, processing loads may be distributed across multiple devices such that operations of the interactive controller may be dedicated to the interactive application and the processes of the process controller and/or wagering subcontroller are not burdened by the requirements of the interactive application.

In many embodiments, a skill compensated interactive wagering system operates with its components being distributed across multiple devices. These devices can be connected by communication channels including, but not limited to, local area networks, wide area networks, local communication buses, and/or the like. The devices may communicate using various types of protocols, including but not limited to, networking protocols, device-to-device communications protocols, and the like.

In some embodiments, one or more components of a skill compensated interactive wagering system are distributed in close proximity to each other and communicate using a local area network and/or a communication bus. In several embodiments, an interactive controller and a process controller of a skill compensated interactive wagering system are in a common location and communicate with an external wagering subcontroller. In some embodiments, a process controller and a wagering subcontroller of a skill compensated interactive wagering system are in a common location and communicate with an external interactive controller. In many embodiments, an interactive controller, a process controller, and a wagering subcontroller of a skill compensated interactive wagering system are located in a common location. In some embodiments, a session subcontroller is located in a common location with a process controller and/or a wagering subcontroller.

In various embodiments, these multiple devices can be constructed from or configured using a single device or a plurality of devices such that a skill compensated interactive wagering system is executed as a system in a virtualized space such as, but not limited to, where a process controller is a large scale centralized server in a cloud networking environment operatively connected to widely distributed interactive controllers via a wide area network such as the Internet or a local area network. In such embodiments, the components of a skill compensated interactive wagering system may communicate using a networking protocol or other type of device-to-device communications protocol.

In some embodiments, a skill compensated interactive wagering system is deployed over a local area network or a wide area network in a mobile configuration. A mobile configuration of a skill compensated interactive wagering system is useful for deployment over wireless communication network, such as a wireless local area network or a wireless telecommunications network. A mobile configuration of a skill compensated interactive wagering system includes an interactive controller operatively connected by a wireless network to a process controller and a wagering subcontroller.

In numerous embodiments, an interactive application server provides a host for managing head-to-head play operating over a network of interactive controllers connected to the interactive application server using a communication link. The interactive application server provides an environment where players can compete directly with one another and interact with other players.

In some embodiments, an interactive controller may be constructed from or configured using an electronic gaming machine 315, such as a slot machine or the like. The electronic gaming machine 315 may be physically located in various types of gaming establishments.

In many embodiments, an interactive controller may be constructed from or configured using a portable device 310. The portable device 310 is a device that may wirelessly connect to a network. Examples of portable devices include, but are not limited to, a tablet computer, a personal digital assistant, and a smartphone.

In some embodiments, an interactive controller may be constructed from or configured using a gaming console 312.

In various embodiments, an interactive controller may be constructed from or configured using a personal computer 314.

In some embodiments, one or more processing devices, such as devices 310, 312, 314, 315 and a virtual reality gaming machine may be used to construct a complete skill compensated interactive wagering system and may be operatively connected using a communication link to a session and/or management controller.

Some skill compensated interactive wagering systems in accordance with many embodiments of the invention can be distributed across a plurality of devices in various configurations. One or more interactive controllers of a distributed skill compensated interactive wagering system, such as but not limited to, a mobile or wireless device 310, a gaming console 312, a personal computer 314, an electronic gaming machine 315, and a virtual reality gaming machine are operatively connected with a process controller 318 of a distributed skill compensated interactive wagering system using a communication link 320. Communication link 320 is a communications link that allows processing systems to communicate with each other and to share data. Embodiments of a communication link include, but are not limited to: a wired or wireless interdevice communication link; a serial or parallel interdevice communication bus; a wired or wireless network such as a Local Area Network (LAN), a Wide Area Network (WAN), or the link; or a wired or wireless communication network such as a wireless telecommunications network or plain old telephone system (POTS). In some embodiments, one or more processes of an interactive controller and a process controller as described herein are executed on the individual interactive controllers 310, 312, 314, 315 and a virtual reality gaming machine while one or more processes of a process controller as described herein can be executed by the process controller 318.

In many embodiments, a distributed skill compensated interactive wagering system and may be operatively connected using a communication link to a session controller (not shown), that performs the processes of a session controller as described herein.

In several embodiments, a distributed skill compensated interactive wagering system and may be operatively connected using a communication link to credit processing system 311, that performs the processes of one or more credit processing systems as described herein.

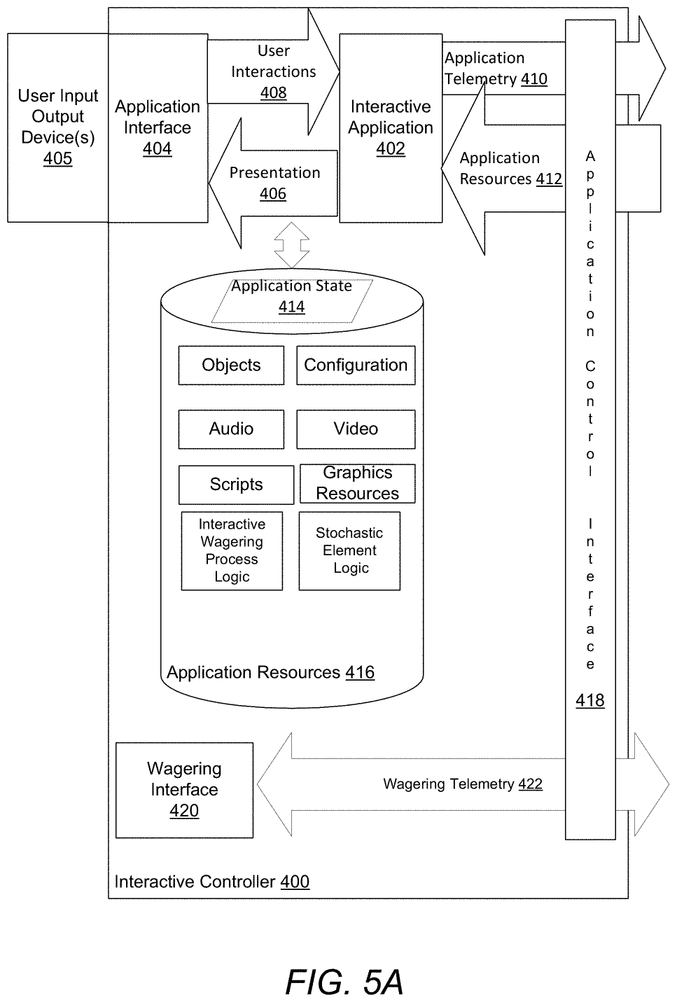

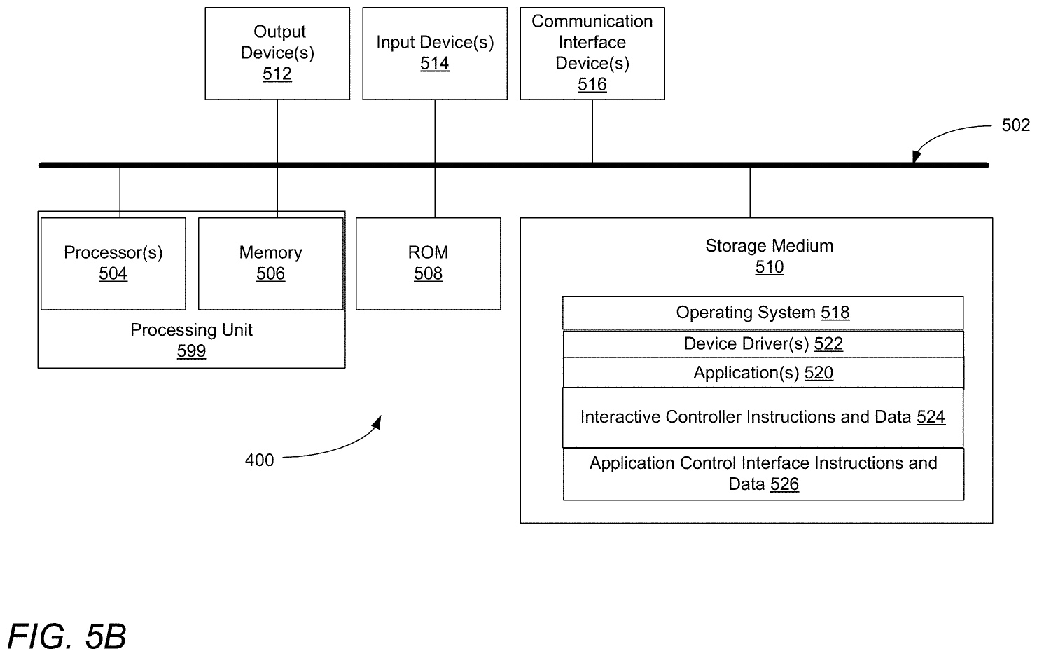

FIGS. 5A and 5B are architecture diagrams of an interactive controller in accordance with various embodiments of the invention. Referring now to FIG. 5A, an interactive controller 400, suitable for use as interactive controller 102 of FIG. 2, provides an execution environment for an interactive application 402 of a skill compensated interactive wagering system. In several embodiments, an interactive controller 400 of a skill compensated interactive wagering system provides an interactive application 402 that generates an application interface 404 for interaction with by one or more players. The interactive application 402 generates an interactive user interface 406 that is presented to the player through the application interface 404 using one or more user input and output devices 405. The interactive user interface 406 may include audio features, visual features or tactile features, or any combination of these features. In various embodiments, the application interface 404 utilizes one or more user interface input and output devices 405 so that a player can interact with the interactive user interface 406. In various embodiments, user input devices include, but are not limited to: buttons or keys; keyboards; keypads; game controllers; joysticks; computer mice; track balls; track buttons; touch pads; touch screens; accelerometers; motion sensors; video input devices; microphones; and the like. In various embodiments, user output devices include, but are not limited to: audio output devices such as speakers, headphones, earbuds, and the like; visual output devices such as lights, video displays and the like; and tactile devices such as rumble pads, hepatic touch screens, buttons, keys and the like. The player's interactions 408 are included by the interactive application 402 in application telemetry data 410 that is communicated by interactive controller 400 to various other components of a skill compensated interactive wagering system as described herein. The interactive application 402 receives application resources 412 communicated from various other components of a skill compensated interactive wagering system as described herein. In some embodiments, the application telemetry data 410 may include player interactions with objects of the interactive application and a wager outcome state of an interactive wagering process presented to the player by the interactive application 402.

In some embodiments, various components of the interactive application 402 can read data from an application state 414 in order to provide one or more features of the interactive application. In various embodiments, components of the interactive application 402 can include, but are not limited to: a physics engine; a rules engine; an audio engine; a graphics engine and the like. The physics engine is used to simulate physical interactions between interactive elements in the interactive application 402. The rules engine implements the rules of the interactive application and a random number generator that may be used for influencing or determining certain variables and/or outcomes to provide a randomizing influence on the operations of the interactive application. The graphics engine is used to generate a visual representation of the interactive application state to the player. The audio engine is used to generate an audio representation of the interactive application state to the player.

During operation, the interactive application reads and writes application resources 416 stored on a data store of the interactive controller 400. The application resources 416 may include objects having graphics and/or control logic used to provide interactive elements of the interactive application. In various embodiments, the resources may also include, but are not limited to, video files that are used to generate a portion of the interactive user interface 406; audio files used to generate music, sound effects, etc. within the interactive application; configuration files used to configure the features of the interactive application; scripts or other types of control code used to provide various features of the interactive application; graphics resources such as textures, objects, etc. that are used by a graphics engine to render objects displayed in an interactive application; interactive wagering process logic used to determine a wager outcome state of an interactive wagering process using player interactions with the interactive user interface; and stochastic element logic used by the interactive application to generate one or more stochastic elements used as application resources.

In operation, components of the interactive application 402 read portions of the application state 414 and generate the interactive user interface 406 for the player that is presented to the player using the user interface 404. The player perceives the interactive user interface and provides player interactions 408 using the user input devices. The corresponding player interactions are received as player actions or inputs by various components of the interactive application 402. The interactive application 402 translates the player actions into interactions with the interactive elements of the interactive application. Components of the interactive application use the player interactions with the interactive elements of the interactive application and the interactive application state 414 to update the application state 414 and update the interactive user interface 406 presented to the player. The process loops continuously while the player interacts with the interactive application of the skill compensated interactive wagering system.

The interactive controller 400 provides one or more interfaces 418 between the interactive controller 400 and other components of a skill compensated interactive wagering system, such as, but not limited to, a process controller. The interactive controller 400 and the other skill compensated interactive wagering system components communicate with each other using the interface. The interface may be used to pass various types of data, and to communicate and receive messages, status data, commands and the like. In certain embodiments, the interactive controller 400 and a process controller communicate application resources 412 and application telemetry data 410. In some embodiments, the communications include requests by the process controller that the interactive controller 400 update the application state 414 using data provided by the process controller.

In many embodiments, communications between a process controller and the interactive controller 400 includes a request that the interactive controller 400 update one or more resources 416 using data provided by the process controller. In a number of embodiments, the interactive controller 400 provides all or a portion of the application state to the process controller. In some embodiments, the interactive controller 400 may also provide data about one or more of the application resources 416 to the process controller. In some embodiments, the communication includes player interactions that the interactive controller 400 communicates to the process controller. The player interactions may be low level player interactions with the user interface 404, such as manipulation of an input device, or may be high level player interactions with game world objects as detected by the interactive application. The player interactions may also include resultant actions such as modifications to the application state 414 or game resources 416 resulting from the player's interactions taken in the skill compensated interactive wagering system interactive application. In some embodiments, player interactions include, but are not limited to, actions taken by entities such as non-player characters (NPCs) of the interactive application that act on behalf of or under the control of the player.

In various embodiments, the application resources 412 include application resources used by the interactive application 402 to generate an interactive user interface of an interactive wagering process presented to a player and to detect a wager outcome state based on the player's skillful interaction with the. In many such embodiments, data of the application resources 412 includes data of one or more stochastic elements as described herein.

In some embodiments, the interactive controller 400 includes a wagering user interface 420 used to provide skill compensated interactive wagering system telemetry data 422 to and from the player. The skill compensated interactive wagering system telemetry data 422 from the skill compensated interactive wagering system includes, but is not limited to, data used by the player to configure a wager, data used to communicate a state of an interactive wagering process, and data about a wagering outcome.

In some embodiments, the interactive controller includes one or more sensors (not shown). Such sensors may include, but are not limited to, physiological sensors that monitor the physiology of the player, environmental sensors that monitor the physical environment of the interactive controller, accelerometers that monitor changes in motion of the interactive controller, and location sensors that monitor the location of the interactive controller such as global positioning sensors (GPSs). The interactive controller 400 communicates sensor telemetry data to one or more components of the skill compensated interactive wagering system.

Referring now to FIG. 5B, interactive controller 400 includes a bus 502 that provides an interface for one or more processors 504, random access memory (RAM) 506, read only memory (ROM) 508, machine-readable storage medium 510, one or more user output devices 512 as described herein, one or more user input devices 514 as described herein, and one or more communication interface devices 516 for implementing one or more interfaces as described herein.

The one or more processors 504 may take many forms, such as, but not limited to: a central processing unit (CPU); a multi-processor unit (MPU); an ARM processor; a controller; a programmable logic device; or the like.

In the example embodiment, the one or more processors 504 and the random access memory (RAM) 506 form an interactive controller processing unit 599. In some embodiments, the interactive controller processing unit includes one or more processors operatively connected to one or more of a RAM, ROM, and machine-readable storage medium; the one or more processors of the interactive controller processing unit receive instructions stored by the one or more of a RAM, ROM, and machine-readable storage medium via a bus; and the one or more processors execute the received instructions. In some embodiments, the interactive controller processing unit is an ASIC (Application-Specific Integrated Circuit). In some embodiments, the interactive controller processing unit is a SoC (System-on-Chip).

The one or more communication interface devices 516 provide one or more wired or wireless interfaces for communicating data and commands between the interactive controller 400 and other devices that may be included in a skill compensated interactive wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS) interface, a cellular or satellite telephone network interface; and the like.

The machine-readable storage medium 510 stores machine-executable instructions for various components of the interactive controller, such as but not limited to: an operating system 518; one or more device drivers 522; one or more application programs 520 including but not limited to an interactive application; and skill compensated interactive wagering system interactive controller instructions and data 524 for use by the one or more processors 504 to provide the features of an interactive controller as described herein. In some embodiments, the machine-executable instructions further include application control interface/application control interface instructions and data 526 for use by the one or more processors 504 to provide the features of an application control interface/application control interface as described herein.

In various embodiments, the machine-readable storage medium 510 is one of a (or a combination of two or more of) a hard drive, a flash drive, a DVD, a CD, a flash storage, a solid state drive, a ROM, an EIEPROM, and the like.

In operation, the machine-executable instructions are loaded into memory 506 from the machine-readable storage medium 510, the ROM 508 or any other storage location. The respective machine-executable instructions are accessed by the one or more processors 504 via the bus 502, and then executed by the one or more processors 504. Data used by the one or more processors 504 are also stored in memory 506, and the one or more processors 504 access such data during execution of the machine-executable instructions. Execution of the machine-executable instructions causes the one or more processors 504 to control the interactive controller 400 to provide the features of a skill compensated interactive wagering system interactive controller as described herein

Although the interactive controller is described herein as being constructed from or configured using one or more processors and instructions stored and executed by hardware components, the interactive controller can be constructed from or configured using only hardware components in accordance with other embodiments. In addition, although the storage medium 510 is described as being operatively connected to the one or more processors through a bus, those skilled in the art of interactive controllers will understand that the storage medium can include removable media such as, but not limited to, a USB memory device, an optical CD ROM, magnetic media such as tape and disks. In some embodiments, the storage medium 510 can be accessed by the one or more processors 504 through one of the communication interface devices 516 or using a communication link. Furthermore, any of the user input devices or user output devices can be operatively connected to the one or more processors 504 via one of the communication interface devices 516 or using a communication link.

In some embodiments, the interactive controller 400 can be distributed across a plurality of different devices. In many such embodiments, an interactive controller of a skill compensated interactive wagering system includes an interactive application server operatively connected to an interactive client using a communication link. The interactive application server and interactive application client cooperate to provide the features of an interactive controller as described herein.

In various embodiments, the interactive controller 400 may be used to construct other components of a skill compensated interactive wagering system as described herein.

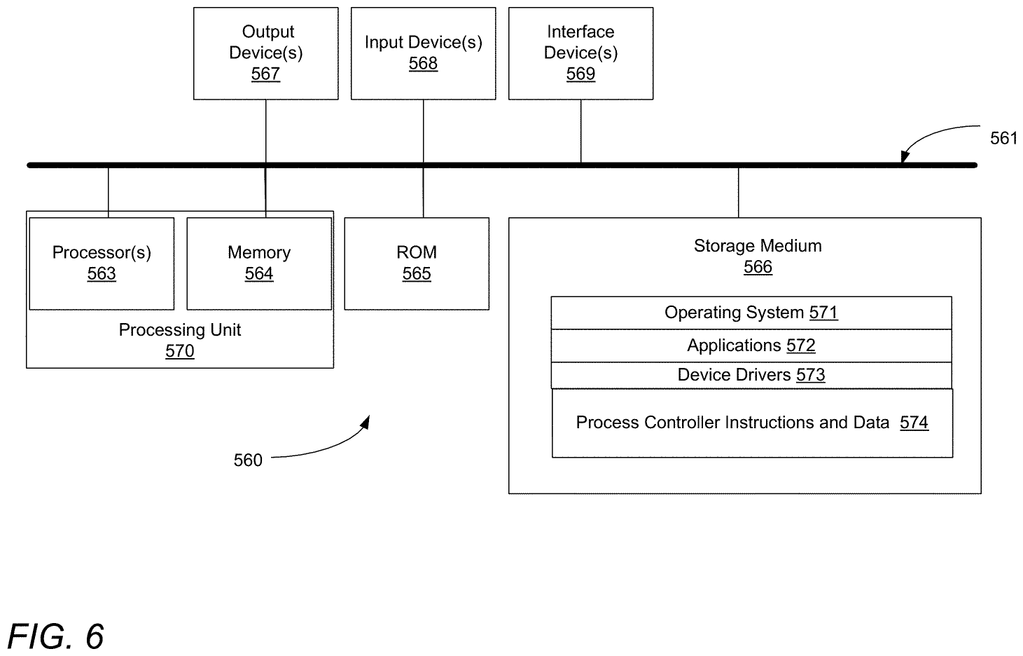

FIG. 6 is an architecture diagram of a process controller, suitable for use as process controller 104 of FIG. 2, of a skill compensated interactive wagering system in accordance with various embodiments of the invention. A process controller may be constructed from or configured using one or more processing devices that perform the operations of the process controller. In many embodiments, a process controller can be constructed from or configured using various types of processing devices including, but not limited to, a mobile device such as a smartphone, a personal digital assistant, a wireless device such as a tablet computer or the like, an electronic gaming machine such as a slot machine, a personal computer, a gaming console, a set-top box, a computing device, a controller, a server, or the like.

Process controller 560 includes a bus 561 providing an interface for one or more processors 563, random access memory (RAM) 564, read only memory (ROM) 565, machine-readable storage medium 566, one or more user output devices 567 as described herein, one or more user input devices 568 as described herein, and one or more communication interface and/or network interface devices 569 used to implement one or more interfaces as described herein.

The one or more processors 563 may take many forms, such as, but not limited to: a central processing unit (CPU); a multi-processor unit (MPU); an ARM processor; a programmable logic device; or the like.

In the example embodiment, the one or more processors 563 and the random access memory (RAM) 564 form a process controller processing unit 570. In some embodiments, the process controller processing unit includes one or more processors operatively connected to one or more of a RAM, ROM, and machine-readable storage medium; the one or more processors of the process controller processing unit receive instructions stored by the one or more of a RAM, ROM, and machine-readable storage medium via a bus; and the one or more processors execute the received instructions. In some embodiments, the process controller processing unit is an ASIC (Application-Specific Integrated Circuit). In some embodiments, the process controller processing unit is a SoC (System-on-Chip).

The one or more communication interface and/or network interface devices 569 provide one or more wired or wireless interfaces for exchanging data and commands between the process controller 560 and other devices that may be included in a skill compensated interactive wagering system. Such wired and wireless interfaces include, but are not limited to: a Universal Serial Bus (USB) interface; a Bluetooth interface; a Wi-Fi interface; an Ethernet interface; a Near Field Communication (NFC) interface; a plain old telephone system (POTS), cellular, or satellite telephone network interface; and the like.

The machine-readable storage medium 566 stores machine-executable instructions for various components of the process controller 560 such as, but not limited to: an operating system 571; one or more applications 572; one or more device drivers 573; and skill compensated interactive wagering system process controller instructions and data 574 for use by the one or more processors 563 to provide the features of a process controller as described herein.

In various embodiments, the machine-readable storage medium 566 is one of a (or a combination of two or more of) a hard drive, a flash drive, a DVD, a CD, a flash storage, a solid state drive, a ROM, an EIEPROM, and the like.

In operation, the machine-executable instructions are loaded into memory 564 from the machine-readable storage medium 566, the ROM 565 or any other storage location. The respective machine-executable instructions are accessed by the one or more processors 563 via the bus 561, and then executed by the one or more processors 563. Data used by the one or more processors 563 are also stored in memory 564, and the one or more processors 563 access such data during execution of the machine-executable instructions. Execution of the machine-executable instructions causes the one or more processors 563 to control the process controller 560 to provide the features of a skill compensated interactive wagering system process controller as described herein.

Although the process controller 560 is described herein as being constructed from or configured using one or more processors and instructions stored and executed by hardware components, the process controller can be composed of only hardware components in accordance with other embodiments. In addition, although the storage medium 566 is described as being operatively connected to the one or more processors through a bus, those skilled in the art of process controllers will understand that the storage medium can include removable media such as, but not limited to, a USB memory device, an optical CD ROM, magnetic media such as tape and disks. Also, in some embodiments, the storage medium 566 may be accessed by processor 563 through one of the interfaces or using a communication link. Furthermore, any of the user input devices or user output devices may be operatively connected to the one or more processors 563 via one of the interfaces or using a communication link.

In various embodiments, the process controller 560 may be used to construct other components of a skill compensated interactive wagering system as described herein.

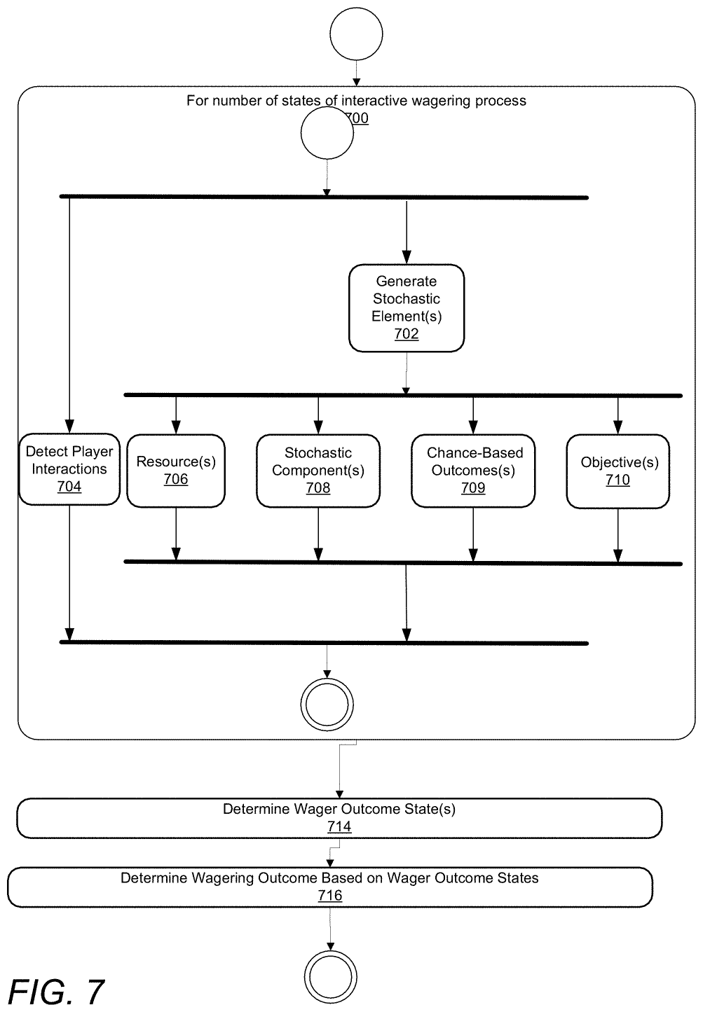

FIG. 7 is an activity diagram of interactive wagering process of a skill compensated interactive wagering system during a wagering session in accordance with various embodiments of the invention. In many embodiments, a skill compensated interactive wagering system determines 716 a wagering outcome for an interactive wagering process by executing one or more iterations of an interactive wagering process where the skill compensated interactive wagering system detects stochastic events in the form of player interactions and generates stochastic events in the form of stochastic elements as described herein. In an example embodiment, an interactive wagering process for a number of states of the interactive wagering process 700, while in a state that is expecting a stochastic transition, the skill compensated interactive wagering system may detect one or more player interactions 704 that cause a transition to a next state; may generate one or more stochastic elements 702 such as one or more resources 706, one or more stochastic components 708, one or more chance-based outcomes 709, and/or one or more objectives 710, thus causing a transition to a next state. The skill compensated interactive wagering system determines 714 one or more wager outcome states. The wager outcome states are determined based on one or more of the detected player interactions, and the one or more stochastic elements. The skill compensated interactive wagering system uses the one or more wager outcome states to determine 716 a wagering outcome for the interactive wagering process.

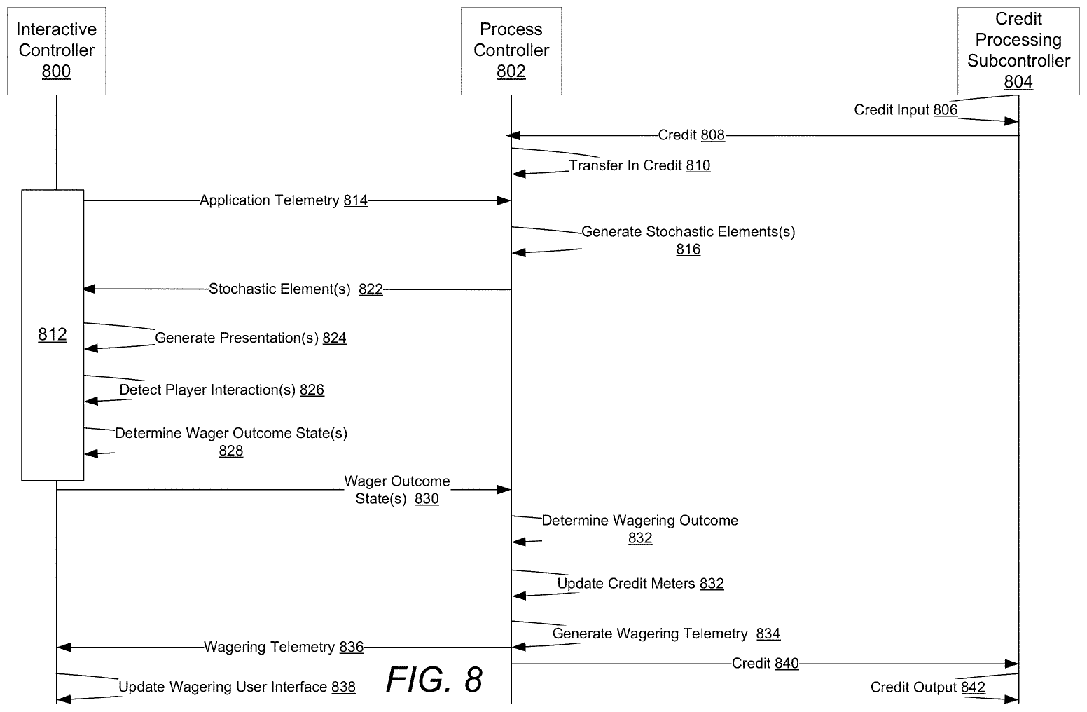

FIG. 8 is a sequence diagram of interactions between components of a skill compensated interactive wagering system during a wagering session in accordance with various embodiments of the invention. In some embodiments, at a beginning of the wagering session, the process includes a credit input 806 to the skill compensated interactive wagering system with a process controller 802 communicating with a credit processing subcontroller 804 to receive incoming credit data 808. The process controller 802 uses the incoming credit data to transfer 810 credits onto one or more player credit meters associated with one or more players of the skill compensated interactive wagering system, thus transferring credits into the skill compensated interactive wagering system and on to the one or more player credit meters.

During an interactive wagering process 812, an interactive controller 800 communicates application telemetry data 814 to the process controller 802. The application telemetry data 814 includes, but is not limited to, data of one or more player interactions detected by the interactive controller 800 and/or one or more interactive application events.

The process controller 802 receives the application telemetry data 814. Upon determination by the process controller 802 that the application telemetry indicates a stochastic element of the interactive wagering process is to be generated in accordance with a state of the interactive wagering process, the process controller 802 generates 816 one or more stochastic elements. The process controller 802 communicates data of the stochastic elements 822 to the interactive controller 800.

The interactive controller 800 receives the stochastic element data 822 from the process controller 802 and uses the stochastic element data 822 to generate an interactive user interface for presentation to the player. The interactive user interface is presented to the one or more players in a user interface of the interactive application of the interactive controller 800. The interactive controller 800 detects 826 one or more player interactions of the one or more players with interactive elements of the interactive user interface and determines 828 one or more wager outcome states for the interactive wagering process based on the detected player interactions. The interactive controller 800 communicates data of the one or more wager outcome states 830 to the process controller 802.

The process controller 802 receives the wager outcome state data 830 and determines 832 a wagering outcome for the interactive wagering process using the data of the one or more wager outcome states. The process controller updates 832 the one or more player credit meters associated with the one or more players based on the wagering outcome for the interactive wagering process, such as by incrementing an amount of credit to, or decrementing an amount of credit from, the one or more player credit meters.

The process controller 802 generates 834 wagering telemetry data 836 using the wagering outcome and data of the updated one or more credit meters. The process controller 802 communicates the wagering telemetry data 836 to the interactive controller 800. The interactive controller 800 receives the wagering telemetry data 836 and the interactive controller 800 updates 838 a wagering user interface on a partial basis of the wagering telemetry data 836.

In many embodiments, upon determining that a wagering session is completed, such as by receiving a cashout communication from one or more players of the skill compensated interactive wagering system, the process controller 802 transfers credits off of the one or more player credit meters, generates outgoing credit data 840 on the basis of the credits transferred off of the one or more player credit meters, and communicates the outgoing credit data 840 to the credit processing subcontroller 804. The credit processing subcontroller 804 receives the outgoing credit data 840 and generates 842 a credit output as described herein, thus transferring credits off of the one or more player credit meters and out of the skill compensated interactive wagering system.

In various embodiments, a process controller provides one or more stochastic components to an interactive controller. The interactive controller receives the stochastic components and uses the stochastic components to generate one or more stochastic elements of an interactive wagering process as described herein.

In many embodiments, one or more stochastic components are used to generate one or more chance-based outcomes that are used to determine a wagering outcome.

In some embodiments, at a beginning of the wagering session, the process includes an application credit input to the skill compensated interactive wagering system with the process controller 802 communicating with the credit processing subcontroller 803 to receive incoming application credit data. The process controller 802 uses the incoming application credit data to transfer application credits onto one or more application credit meters associated with one or more players of the skill compensated interactive wagering system, thus transferring application credits into the skill compensated interactive wagering system and on to the one or more application credit meters. The process controller 802 uses intermediate state data of an interactive application to generate an amount of application credit to award to a player based on the player's achievement of one or more objectives of the interactive application. Upon determining that the wagering session is completed, such as by receiving a cashout communication from one or more players of the skill compensated interactive wagering system, the process controller 802 transfers application credits off of the one or more application credit meters, generates outgoing application credit data on the basis of the application credits transferred off of the one or more application credit meters, and communicates the outgoing application credit data to the credit processing subcontroller 803. The credit processing subcontroller receives the outgoing application credit data and generates an application credit output as described herein, thus transferring application credits off of the one or more application credit meters and out of the skill compensated interactive wagering system.

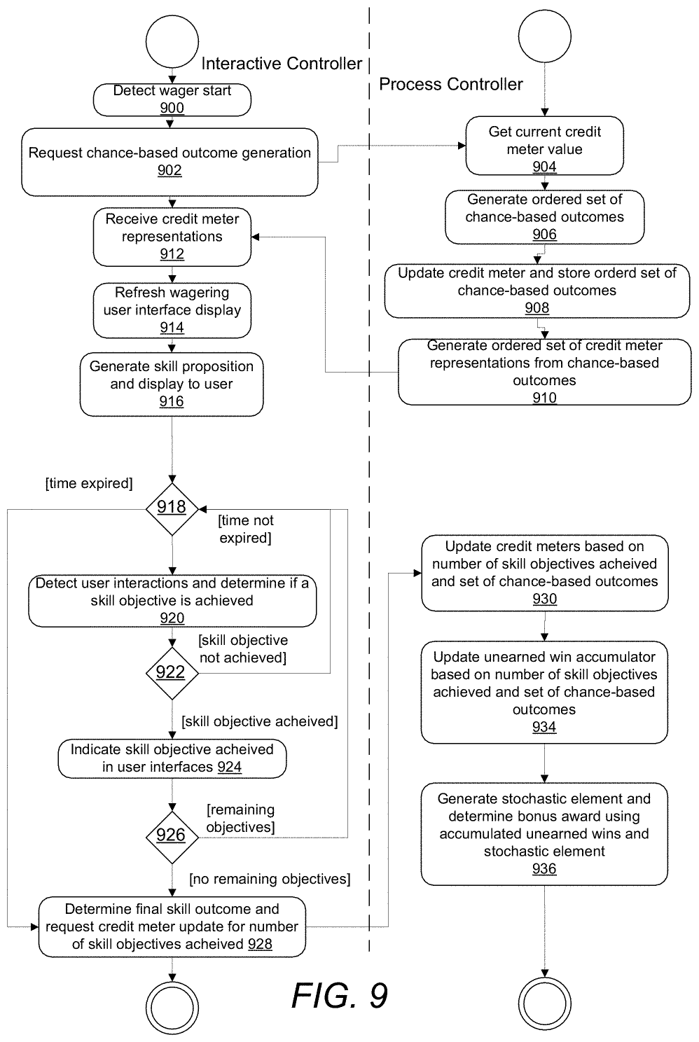

FIG. 9 is an activity diagram of a process of an interactive application and a wagering user interface of a skill compensated interactive wagering system in accordance with various embodiments of the invention. An interactive controller detects 900 a wager start event based on a user's interactions with an interactive application of the interactive controller. The interactive controller requests 902 chance-based outcome generation from a process controller. In response to the request for chance-based outcomes, the process controller gets 904 current credit meter data values from one or more credit meters associated with the user. The process controller generates 906 an ordered set of chance-based outcomes. The process controller updates 908 one or more intermediate credit meters based on the ordered set of chance-based outcomes and decrements the one or more credit meters associated with the user of an amount of credits utilized by the process controller to generate the ordered set of chance-based outcomes. The process controller generates 910 one or more sets of ordered credit meter representations using the ordered set of chance-based outcomes. The process controller communicates data of the sets of ordered credit meter representations to the interactive controller.

The interactive controller receives 912 the one or more ordered sets of credit meter representations and updates or refreshes 914 a wagering user interface display using the one or more ordered sets of credit meter representations. The interactive controller generates 916 and presents a skill proposition in an interactive application user interface to a user. The skill proposition includes a specified number of skill objectives and a specified period of time that a user is provided to achieve the specified number of skill objectives. While the interactive controller determines that the specified period of time has not expired 918, the interactive controller detects 920 user interactions with the interactive application user interface and determines from the user interactions whether or not the user has achieved a skill objective. If the interactive controller determines 922 the user has not achieved a skill objective, the interactive controller continues to detect user interactions with the interactive application user interface as long as the interactive controller determines the specified period of time has not expired. If the interactive controller determines a skill objective has been achieved by the user, the interactive controller generates 924 a display in the interactive application user interface indicating that a skill objective has been achieved and updates the wagering user interface using respective credit meter representations included in the one or more ordered sets of credit meter representations. If the interactive controller determines 926 there are more skill objectives to be achieved, and the interactive controller determines the specified time period has not expired, the interactive controller continues to detect user interactions with the interactive application user interface to determine if a skill objective has been achieved.

If the interactive controller determines that the specified time period has expired and/or that there are no more remaining skill objectives to be achieved, the interactive controller communicates 928 data of a final skill outcome including data of a number of skill objectives achieved by the user. The process controller receives the final skill outcome data and uses the final skill outcome data and the ordered set of chance-based outcomes to update 930 one or more credit meters associated with the user. The process controller updates unearned win accumulator based on number of skill objectives achieved and set of chance-based outcomes 934. The process controller generates a stochastic element and determines a bonus award using accumulated unearned wins and stochastic element 936.

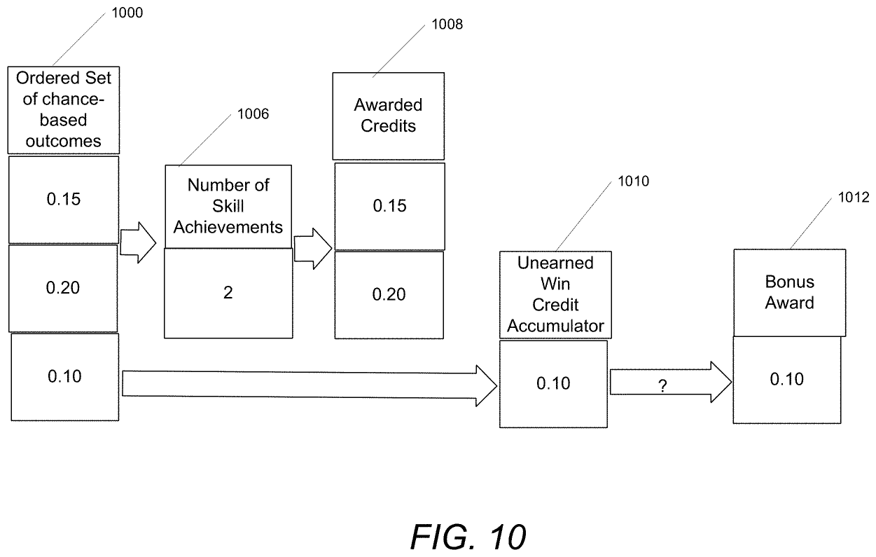

FIG. 10 is a block diagram of a process of a skill compensated interactive wagering system in accordance with an embodiment of the invention. A skill compensated interactive wagering system generates an ordered set of chance-based outcomes 1000, as illustrated by the values 0.15, 0.20 and 0.10 that are the credit amounts that will be awarded to a user if the user achieves all of one or more respective skill objectives that are generated by the skill compensated interactive wagering system and presented to the user. The skill compensated interactive wagering system determines a number of skill objectives 1006 achieved by the user, in the illustrated embodiment the user has achieved two skill objectives. The skill compensated interactive wagering system determines form the ordered set of chance-based outcomes how many credits 1008 are to be awarded to the user. In the illustrated embodiment, an amount of credits awarded to the user for achieving the first skill objective is 0.15 and an amount of credits awarded to the user for achieving the second skill objective is 0.20. The skill compensated interactive wagering system takes the unearned credits, 0.10 and adds them to an unearned win credit accumulator 1010. Credits from the unearned win credit accumulator are used to generate a bonus award that is awarded to a player on the basis of a stochastic element and an amount of credit in the unearned win credit accumulator 1012.

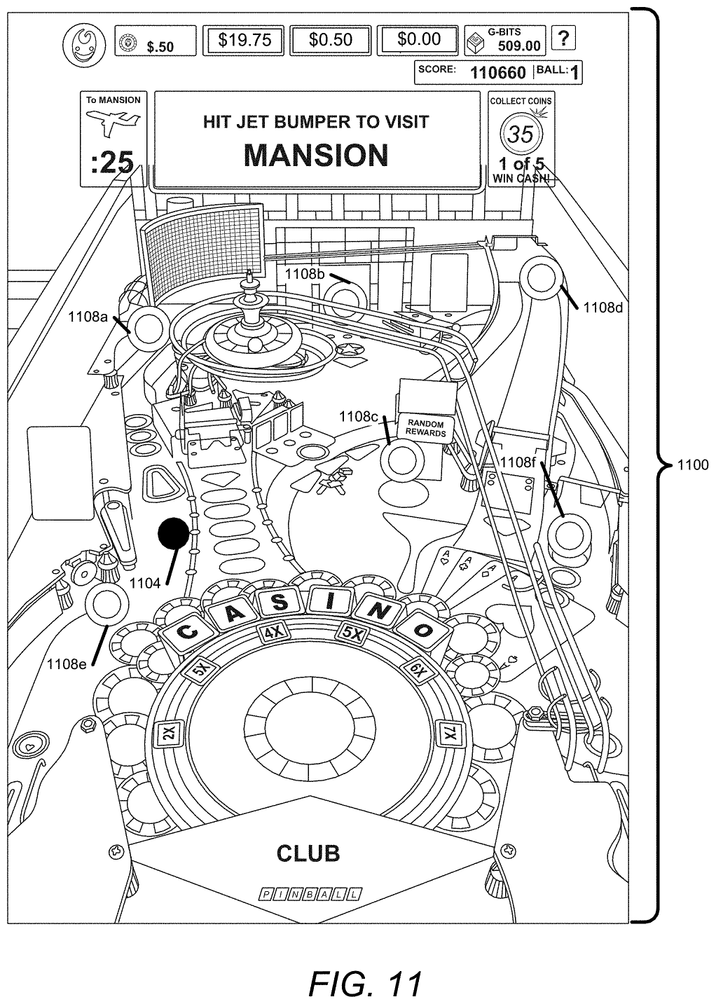

FIG. 11 illustrates a user interface 1100 of an interactive skill-based game of a skill compensated interactive wagering system in accordance with an embodiment of the invention. The skill-based game is a virtual pinball game. In operation, the system generates a plurality of chance-based outcomes of an amount of credits that are associated with respective virtual target objects 1108a to 1108f that the player attempts to virtually strike with a virtual pinball. One skill-based objective for the player to achieve through skillful play is for the player to strike the virtual target objects with the virtual pinball. Each time the player does so, the player is awarded the chance-based outcome associated with the virtual target object. As in a conventional pinball game, the player may lose the virtual pinball through less skillful interactions and the player will not be able to virtually strike all of the virtual target objects and will not be awarded some of the chance-based outcomes, that is, the chance-based outcomes that are not awarded are unearned wins. The chance-based outcomes that are not awarded to the player are collected in an unearned win accumulator and awarded to the player as described herein.

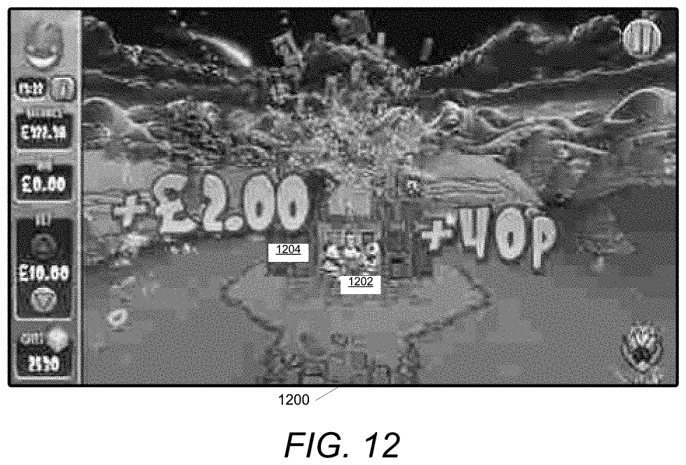

FIG. 12 illustrates a user interface 1200 of another interactive skill-based game of a skill compensated interactive wagering system in accordance with an embodiment of the invention. The skill-based game is a three-dimensional physics puzzle game wherein the player attempts to strike virtual objects with a virtual projectile launched from a virtual catapult. The game is presented to the player in a first person perspective from behind the virtual catapult. In operation, the system generates a plurality of chance-based outcomes of an amount of credits that are associated with respective virtual objects. The virtual objects are positioned on various platforms that the player attempts to virtually destroy with the virtual projectile, thus causing the virtual objects to fall. In an embodiment, the virtual objects are knights 1202 and the virtual platforms are battlements 1204 protecting the knights. One skill-based objective for the player to achieve through skillful play is for the player to cause all the virtual objects to fall to the ground. Each time the player does so, the player is awarded a chance-based outcome associated with the virtual object. The player may fail to virtually destroy the virtual platforms through less skillful interactions and the player will not be awarded some of the chance-based outcomes associated with virtual objects that have not fallen, that is, the chance-based outcomes that are not awarded are unearned wins. The chance-based outcomes that are not awarded to the player are collected in an unearned win accumulator and awarded to the player as described herein.

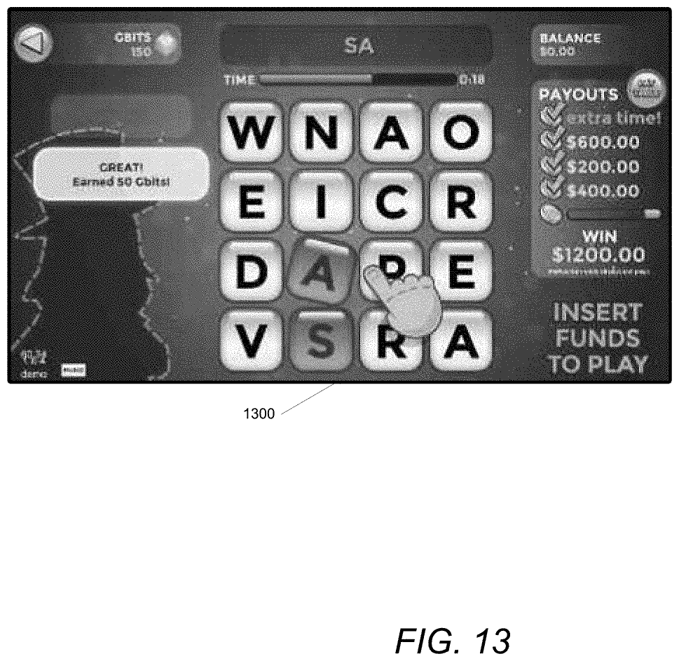

FIG. 13 illustrates a user interface 1300 of another interactive skill-based game of a skill compensated interactive wagering system in accordance with an embodiment of the invention. The skill-based game is a word spelling puzzle game wherein the player attempts to spell words using letters randomly distributed in a 4×4 grid. In operation, the system generates a plurality of chance-based outcomes of an amount of credits that are associated with respective skill-based objectives that the player is to achieve. In an embodiment, each respective skill-based objective is a specified number of words that the player is able to spell. Each time the player achieves an objective the player is awarded a respective chance-based outcome associated with the virtual object. The player may fail to achieve all of the skill-based objectives and the player will not be awarded some of the chance-based outcomes associated with respective skill-based objective, that is, the chance-based outcomes that are not awarded are unearned wins. The chance-based outcomes that are not awarded to the player are collected in an unearned win accumulator and awarded to the player as described herein.

In an embodiment, a player may earn up to 5 chance-based outcomes in the form of coins for spelling words. Unearned wins are accumulated in the unearned win accumulator when the player achieves less than all 5 chance-based outcomes, allowing spelling pays across all 5 chance-based outcomes.

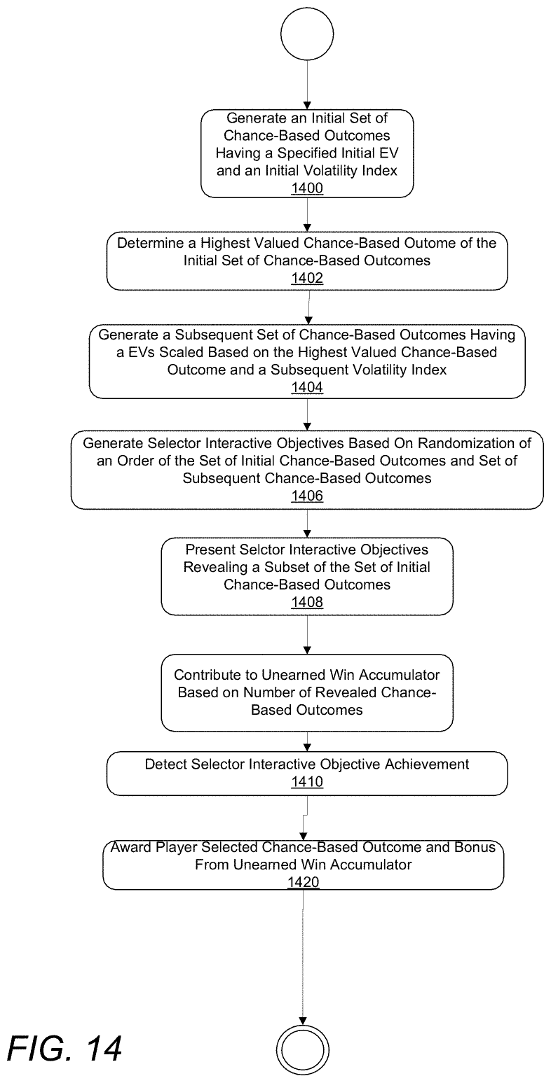

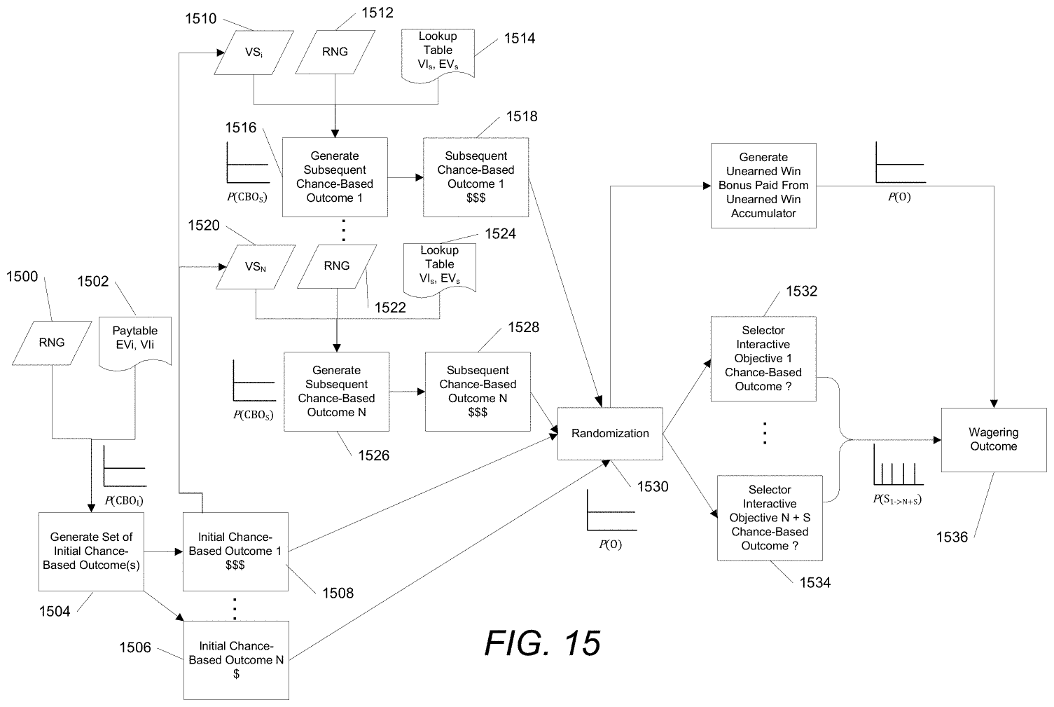

FIG. 14 is an activity diagram of a process for generating an outcome selector of a skill compensating interactive wagering system having multiple volatility indexes and FIG. 15 is a data flow diagram of a process for generating an outcome selector of a skill compensating interactive wagering system having multiple volatility indexes.

In some embodiments of a skill compensated interactive wagering system, a player plays a skill-based interactive game to achieve one or more skill objectives. In a chance-based interactive game, the player is presented with an outcome selector or “picker” from which the player selects or picks a chance-based outcome of an amount of credits as an award for an interactive wagering game. In the outcome selector, a plurality of chance-based outcomes are made selectable, but the values of the chance-based outcomes are hidden from the player. The system reveals none or more of the chance-based outcomes to the player depending on the number of skill objectives that the player has achieved. In an example embodiment, the outcome selector has 9 selectable positions arranged in a 3×3 grid. The player can achieve up to 3 skill objectives in the associated skill-based interactive game. If the player does not achieve any of the skill objectives, no chance-based outcomes are revealed to the player. If the player achieves one objective, then one chance-based outcome is revealed to the player. If the player achieves two objectives, then two chance-based outcomes are revealed to the player. If the player achieves three objectives, then three chance-based outcomes are revealed to the player. Therefore it is to the player's advantage to see more of the hidden chance-based outcomes and the expected value of the amount of credits awarded to the player is increased the more chance-based outcomes are revealed to the player. That is, EV3>EV2>EV1>EV0 where EV3 is the expected value when three hidden values are revealed, EV2 is the expected value when two hidden values are revealed, EV1 is the expected value when one hidden value is revealed, and EV0 is the expected value when no hidden values are revealed.

A volatility index for a set of chance-based outcomes generated by a skill compensated interactive wagering system is a measure of how the chance-based outcomes vary as a sequence of chance-based outcomes are generated. A set of chance-based outcomes having low volatility index does not have a large variance in chance-based outcomes, while a set of chance-based outcomes with a high volatility index has large variances in chance-based outcomes. A volatility index is analogous to a confidence interval for set of data.

Chance-based outcomes can be generated using a lookup table of chance-based outcomes and a stochastic element as an index into the lookup table as described herein. A volatility index for a set of chance-based outcomes generated using a lookup table can be calculated by:

Vi=C*\sqrt{Σᵢ₌₁^{N}Pᵢ(Oᵢ−EV)²}

Where:

Vi=Volatility index in units of wager value.

C=critical value of the confidence interval.

N=number of unique chance-based outcomes in the lookup table.

Oi=value of the ith unique chance-based outcome in units of wager value.

Pi=probability that chance-based Oi will be generated.

EV=expected value of set of chance-based outcomes generated using the lookup table in units of wager value.

Referring now to both FIG. 14 and FIG. 15, during a process for generating an outcome selector of a skill compensated interactive wagering system, skill compensated interactive wagering system generates, 1400 and 1504, an initial set of chance-based outcomes, as exemplified by initial chance-based outcomes 1506 and 1508. The initial set of chance-based outcomes are generated using an output of a random number generator 1500 and a lookup table 1502 that defines a set of chance-based outcomes that have a specified initial expected value and an initial volatility index. The system determines 1402 a highest valued chance-based outcome of the initial set of chance-based outcomes. The system generates, 1404, 1516, and 1526, one or more subsequent sets of chance-based outcomes, such as subsequent set of chance-based outcomes 1518 and 1528, having expected values 1510 and 1520, based on the highest valued chance-based outcome of the initial set of chance-based outcomes and a subsequent volatility index, using an output of a random number generator, 1512 and 1522, and lookup tables, 1514 and 1524. The system uses the initial set of chance-based outcomes and the one or more or subsequent sets of chance-based outcomes to generate 1406 two or more selector interactive objectives, such as selector interactive objectives 1532 and 1534, based on a randomization 1530 of an order of the initial set of chance-based outcomes and the one or more subsequent sets of chance-based outcomes. The selector interactive objectives are presented 1408 to a player with one or more values of the chance-based outcomes hidden from the player and none or more of the values of the chance-based outcomes revealed to the player. The system makes a contribution to an unearned win accumulator on the basis of the number of revealed chance-based outcomes, a difference between the player's expectancy of having a maximum number of revealed outcomes and the number of actually revealed outcomes, and an amount of credits that are committed to the wager. The system detects 1410 the player's selection of one of the chance-based outcomes of the selector interactive objective. The system awards 1420 to the player an amount of credits based on the selected chance-based outcome and an amount of credits awarded from the unearned win accumulator as a wagering outcome 1536.

In some embodiments, the selector interactive objective is presented to the player with the highest valued chance-based outcome of the initial set of chance-based outcomes revealed.

In various embodiments, the volatility index of the initial set of chance-based outcomes is lower than the volatility index of the one or more subsequent sets of chance-based outcomes.

In some embodiments, the volatility index of the initial set of chance-based outcomes is higher than the volatility index of the one or more subsequent sets of chance-based outcomes.

In many embodiments, the volatility index of the initial set of chance-based outcomes is the same as the volatility index of the one or more subsequent sets of chance-based outcomes.

In some embodiments, a highest valued chance-based outcome of the initial set of chance-based outcomes is used to determine a set of scaling values that are used to scale the one or more subsequent sets of chance-based outcomes. In an example embodiment, an initial lookup table is used in conjunction with a stochastic element as an index into the lookup table to generate an initial chance-based outcome. The initial lookup table is designed to provide a specified expected value for a specified wager value. In other words, the initial lookup table has a specified initial return to player. The initial chance-based outcome is then used in conjunction with another lookup table to determine a set of scaling values. The set of scaling values are used in conjunction with a subsequent lookup table having a specified expected value that is a fraction of the expected value of the initial lookup table. The size of the set of scaling values is determined based on a number of subsequent chance-based outcomes to be generated for an outcome selector and the values of the scaling values is specified such that an average of the scaling values multiplied by the subsequent lookup table's expected value equals the initial chance-based outcome's value as expressed in the following equation:

$${CBO}_{i} = \frac{{\sum }_{i = 1}^{N} {VS}_{i}}{N} {EV}_{s}$$

Where:

CBOᵢ=initial chance-based outcome

N=number of scaling values in set of scaling values

VSᵢ=ith scaling value

EVₛ=expected value of subsequent lookup table.

In an example embodiment, the expected value of an initial lookup table is 100 credits for 100 credits wagered. A member of a set of possible chance-based outcomes generated using the initial look up table is 300 credits. An expected value of a subsequent lookup table is 25 credits for a 100 credit wager. The size of the set of subsequent chance-based outcomes is 6. In such an example embodiment, a set of scaling values for the chance-based outcome of 300 of the initial lookup table is [3,3,36,6,12,12]. In operation, an initial stochastic element and the initial lookup table are used to generate an initial chance-based outcome. The initial chance-based outcome is used to determine a set of scaling values. For each scaling value, a subsequent stochastic element is generated and used with a subsequent lookup table to generate a chance-based component that is multiplied by the scaling value to determine a subsequent chance-based outcome of the set of subsequent chance-based outcomes. The initial chance-based outcome and the subsequent set of chance-based outcomes are combined through a randomization process to create an outcome selector as described herein.

In some embodiments, the initial chance-based outcome is approximately equal to the average of the scaling values multiplied by the expected value of the subsequent lookup table.

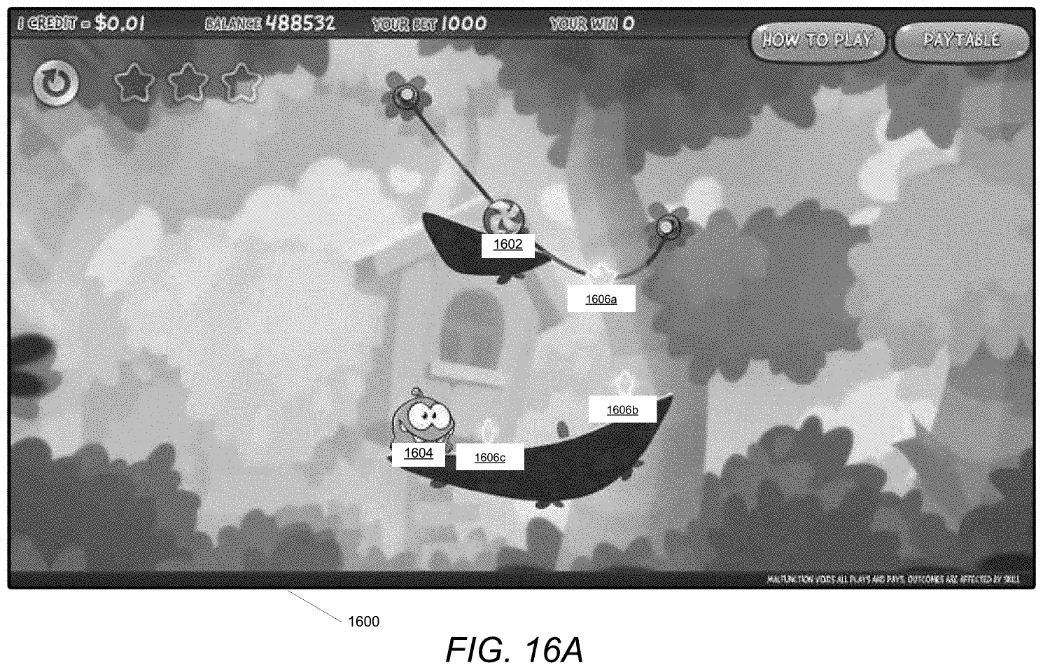

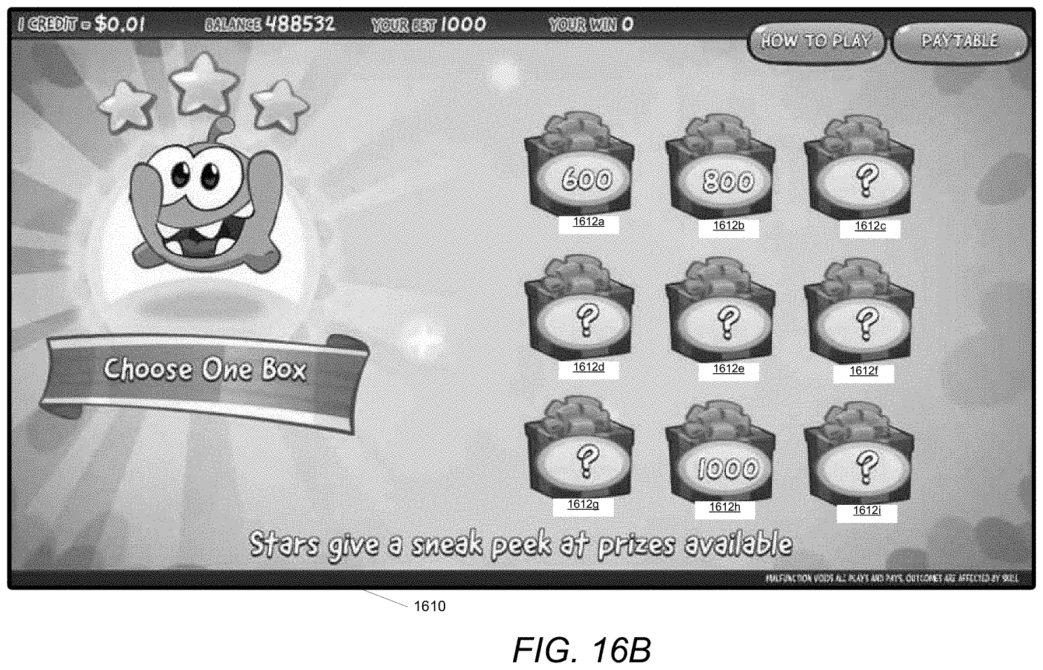

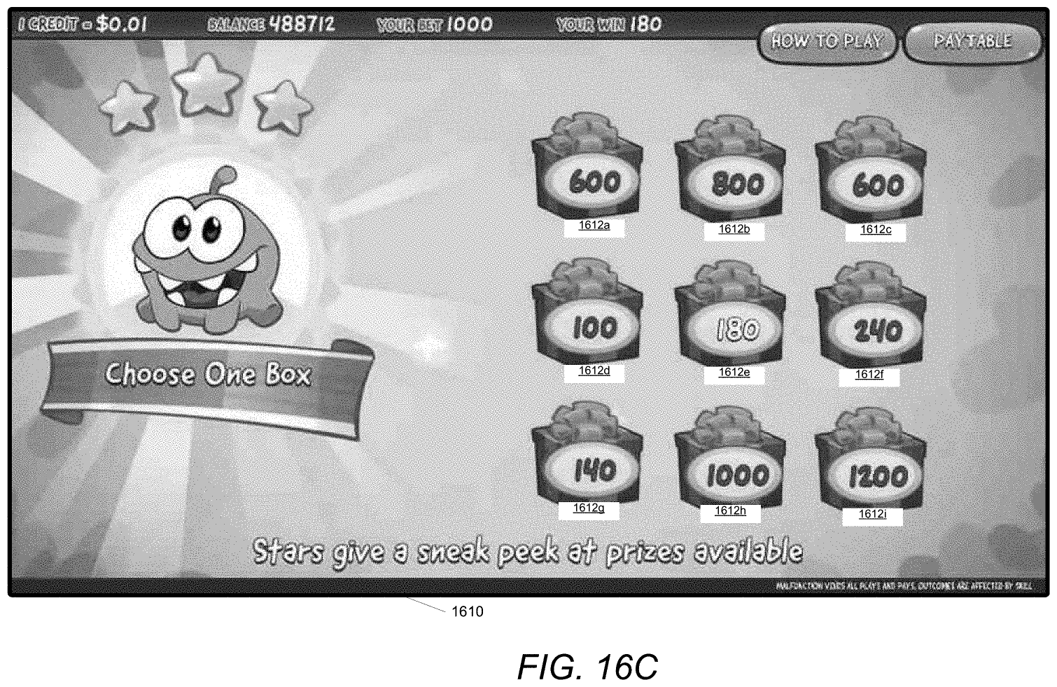

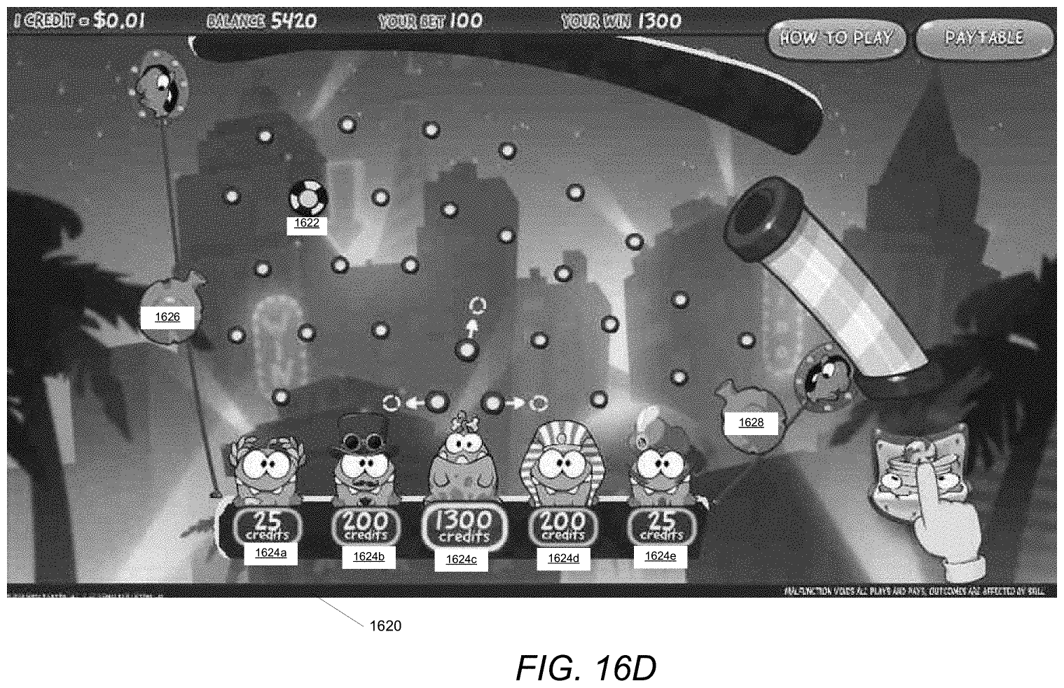

FIGS. 16A, 16B, 16C, and 16D are illustrations of user interfaces of another interactive skill-based game of a skill compensated interactive wagering system in accordance with an embodiment of the invention. In the figures, like reference numerals indicate the same element.

Referring to FIG. 16A, FIG. 16A illustrates a user interface 1600 of a skill-based game that is a two dimensional physics puzzle game wherein the player attempts to guide a virtual object along a specified virtual path to place the virtual object into a virtual receptacle. Along the specified virtual path are virtual target objects that the player attempts to contact with the virtual object. In an embodiment, the virtual object is a cookie 1602, the virtual receptacle is a mouth of a non-player character (NPC) 1604, and the virtual target objects are stars 1606a, 1606b, and 1606c. A skill-based objective for the player to achieve is to contact one or more of the virtual target objects.

Turning now to FIGS. 16B and 16C, FIGS. 16B and 16C illustrate a user interface 1610 for a outcome selector also termed a prize picker. In operation, the system generates an outcome selector having two or more award locations, such as award locations 1612a to 1612i associated with respective two or more chance-based outcomes. Initially, the value of a chance-based outcome associated with a location of the outcome selector is hidden from the player, such as location 1612e. For each objective achieved by the player in the skill-based interactive game, a value of the chance-based outcome associated with a location is revealed to the player, such as at location 1612a. The player may select one of the revealed chance-based outcomes, or may select one of the unrevealed chance-based outcomes as an award. The system detects the player's selection of a hidden or revealed chance-based outcome and awards to the player an award of an amount of credits of the selected chance-based outcome.

In an embodiment, the achieved objectives are represented as virtual stars, the player can achieve from 0 to 3 objectives, and the outcome selector is a 3×3 grid.

The expected value (EV) of an award of credits awarded to the player is dependent upon how many chance-based outcomes are revealed to the player because the player is able to avoid selecting at least some lower valued chance-based outcomes. That is, EVr>EVh where EVr is the expected value awarded to the player when there are revealed chance-based outcomes and EVh is the expected value awarded to a player when all of the chance-based outcomes are hidden. Furthermore, for any number of revealed chance-based outcomes from 1 to n, EVn>EVn-1> . . . EV1>EVh. Therefore, in a case where the player has not achieved all of the available objectives, a difference between any EVr and EVh can be determined as an amount of credits of an unearned win that can be allocated to an unearned win accumulator and awarded to a player as described herein.

Turning now to FIG. 16D, FIG. 16D illustrates a user interface 1620 of an interactive mini-game wherein a bonus award is awarded to a player. In some embodiments, unearned wins are awarded to a player using a skill-based bonus game. All illustrated, a player launches a virtual projectile 1622 in a 2-dimensional physics puzzle. The virtual projectile falls through a series of pins and obstacles and lands on a virtual target object, such as virtual target objects 1624a to 1624e, having a value of an amount of credits that are awarded to the player. The player may guide the projectile as it falls using one or more virtual bellows 1626 and 1628 that apply forces to the projectile.

In some embodiments, the interactive mini-game is a pseudo-skill game, that is, even though the player may interact with the game, the amount of credits to be awarded to the player is predetermined and the virtual projectile's path is determined by the system to land on a predetermined one of the one of the one or more virtual target objects.

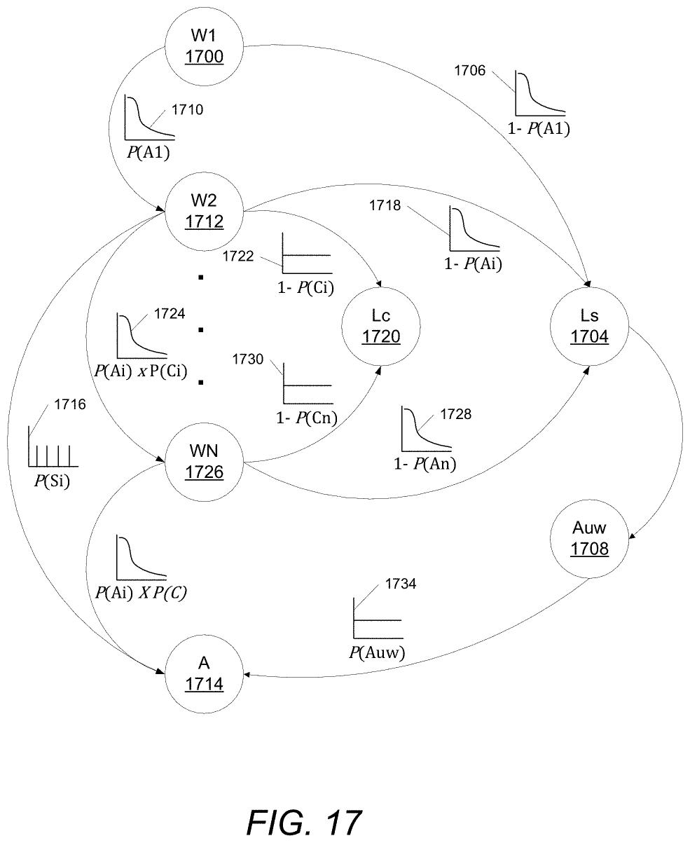

FIG. 17 is a state diagram of a process of a skill compensated interactive wagering system in accordance with various embodiments of the invention. During an interactive wagering process, the system executes a sequence of parlay wagers, that is, one or more of the wagers in the sequence of wagers is dependent upon the outcome of a previous wager.

In an embodiment, the dependency between wagers is that a player commits a wager amount, a stochastic element is generated by the system and an objective is determined for the player to achieve based on the stochastic element. If the player achieves the objective the player receives a specified award of a specified amount of credits and the player is allowed to commit an additional wager for higher stakes. However, if the player fails to achieve the objective, the player loses the wager.

The objective difficulty is determined by the stochastic element such that the generated objective is either easily achievable by the player's skillful play or is extremely difficult to be achieved through skillful play by the player. In other words, when the objective is easy to achieve, the probability that the player has the requisite skill to achieve the objective is high and when the objective is difficult, the probability that the player as the requisite skill to achieve the objective is low. As the objectives are randomly generated using stochastic elements, the probability that a player will be able to achieve an objective is a function of both the probability that the player has the requisite skill to achieve the objective and the probability that an easy objective is generated. That is the probability that an objective is achieved is P(Ai)×P(Ci) where P(Ai) is the probability that a player can achieve objective i, and P(Ci) is the probability that objective i was generated. If the difficulty difference between objectives is extreme enough, that is there is an objective having a P(Ai) much greater than a second objective's P(Ai), when a player fails to achieve an objective, an assumption can be made as to why the player failed to achieve the objective. If the objective's difficulty was low, that is P(Ai) for that objective is high, then the player's failure to achieve the objective can be assumed to be because the player made an error and failed to be awarded the specified amount of credits for achieving the objective and the player lost the wager because the player wasn't skillful enough. That is, the player failed to earn a win that was available to the player, termed an unearned win herein. Accordingly the probability that a player will experience a loss because the player lacked the requisite skill is approximately 1−P(Ai).

Conversely, if the objective difficulty was high, that is the P(Ai) of the objective is low, and the player failed to achieve the objective, the failure to achieve the objective can be attributed to the difficulty of the objective and not to the player's lack of skill. In such a case, the loss of the wager by the player can be attributed to the difficulty of the objective. Accordingly, the probability that a player will experience such a loss of the interactive wager is approximately 1−P(Ci).

In an embodiment, the objective of a first wager of a sequence of wagers is always achievable, that is, it is the first objective's difficulty is such that the always achievable by the player. In other words, P(A1) for the first objective is approximately 1.

In several such embodiments, the player is allowed to exit the wager sequence before the commitment of credits to a subsequent wager allowing the player to avoid the risk that the player will lose the next wager, either through player error or because the objective was too difficult.

Turning to FIG. 17, during the wagering sequence an initial wager is executed by the system while in state W1 1700 and an objective of a skill-based interactive game is generated by the system based on a generated stochastic element and presented to the player as described herein. The system detects the player's interactions while attempting to achieve the objective through skillful play of the interactive game of the skill compensated interactive wagering system. If the system determines that player is unable to achieve the objective, the system transitions to skill loss state Ls 1704 as indicated by a skill transition with a probability of 1−P(Ai) 1706. In skill loss state Ls 1704, the system transitions to an unearned win state Auw 1708, and allocates an amount of credits to an unearned win accumulator. The amount of credits allocated is an amount of credits that the player would have been awarded if the player was able to achieve the first objective.

If the system determines that the player is able to achieve the objective, as indicated by a transition with a probability of P(Ai) 1710, the system transitions to a subsequent wager state W2 1712. While in state W2 1712, the system offers the player an opportunity to select to exit the wager parlay. If the system detects that the player has chosen to exit the wager parlay, the system transitions to an award state A 1714 as indicated by a selector transition having a probability of P(Si) 1716. In award state A 1714, the system awards the player a specified amount of credits for winning the first wager.

If the system detects that the player chooses to commit an additional wager while the system is in wager state W2 1712, the system generates a subsequent objective and the player attempts to achieve the subsequent objective.

If the system determines that the player fails to achieve the subsequent objective and the subsequent objective was an easy objective, that is P(Ai) for the subsequent objective is high and it was anticipated that the player would have the requisite skill to achieve the objective, then the system transitions to skill loss state Ls 1704 as indicated by a skill transition with a probability of 1−P(Ai) 1718 and the amount of credits that the player would have won for achieving the subsequent objective is allocated to the unearned win accumulator.

If the system determines that the player fails to achieve the subsequent objective and the subsequent objective was a difficult objective, that is P(Ai) for the subsequent objective is low and it was anticipated that the player would not have the requisite skill to achieve the objective, then the system transitions to a chance-based loss state LC 1720 with a probability of 1−P(Ci) 1722.

If the system determines that the player achieves the current subsequent objective, the system transitions to another subsequent wager state with a probability of P(Ai)×P(Ci) 1724. Any number of wagers can be in the sequence as indicated by the ellipses. The player may select to exit the parlayed wagers at any wager commitment state.

In a final wager state WN 1726, if the system detects that the player chooses to commit an additional wager while the system is in the wager state, the system generates a final objective and the system detects the player's attempts to achieve the final objective.

If the system determines that the player fails to achieve the final objective and the final objective was an easy objective, that is P(An) for the final objective is high and it was anticipated that the player would have the requisite skill to achieve the final objective, then the system transitions to skill loss state Ls 1704 as indicated by a skill transition with a probability of 1−P(An) 1728 and the system allocates an amount of credits that the player would have won for achieving the final objective to the unearned win accumulator.

If the system determines that the player fails to achieve the final objective and the subsequent objective was a difficult objective, that is P(An) for the final objective is low and it was anticipated that the player would not have the requisite skill to achieve the final objective, then the system transitions to a chance-based loss state LC 1720 with a probability of 1−P(Cn) 1730.

If the system determines that the player achieves the final objective, the system transitions to an award state A 1714 with a probability of P(An)×P(Cn) 1732. In state A 1714 the system awards to the player a specified amount of credits for successfully achieving the final objective.

In addition to the award for achieving the final objective, the system may also award to the player a bonus award of an amount of credits from the unearned win accumulator. Whether or not to award the player from the unearned win accumulator is determined by the system by generating a stochastic element and the system transitions from the award accumulator state Auw 1708 to the award state A 1714 with a probability of P(Auw) 1734.

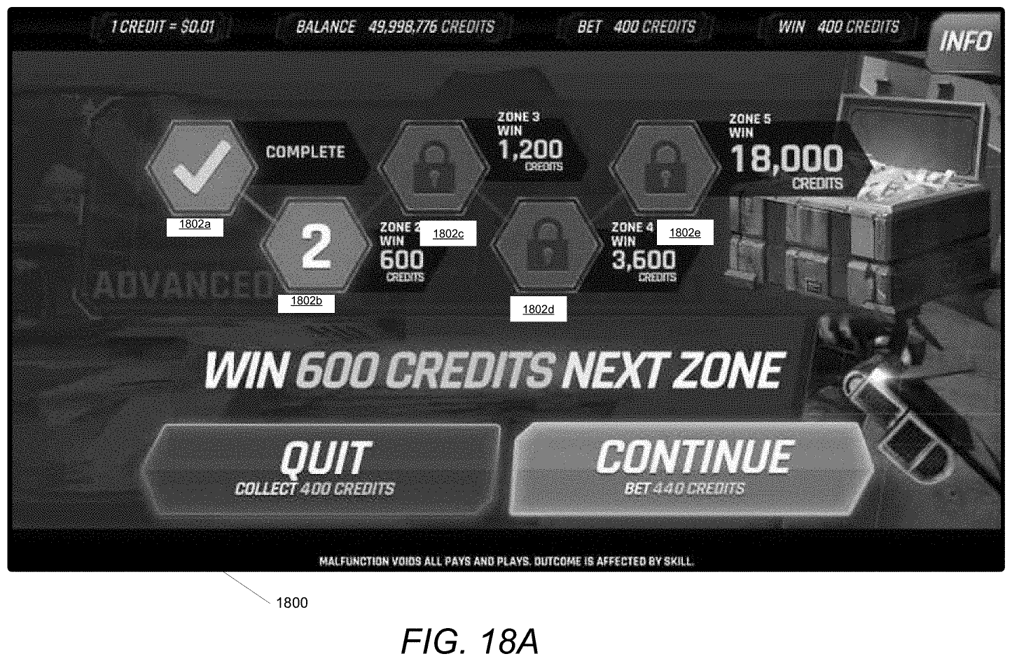

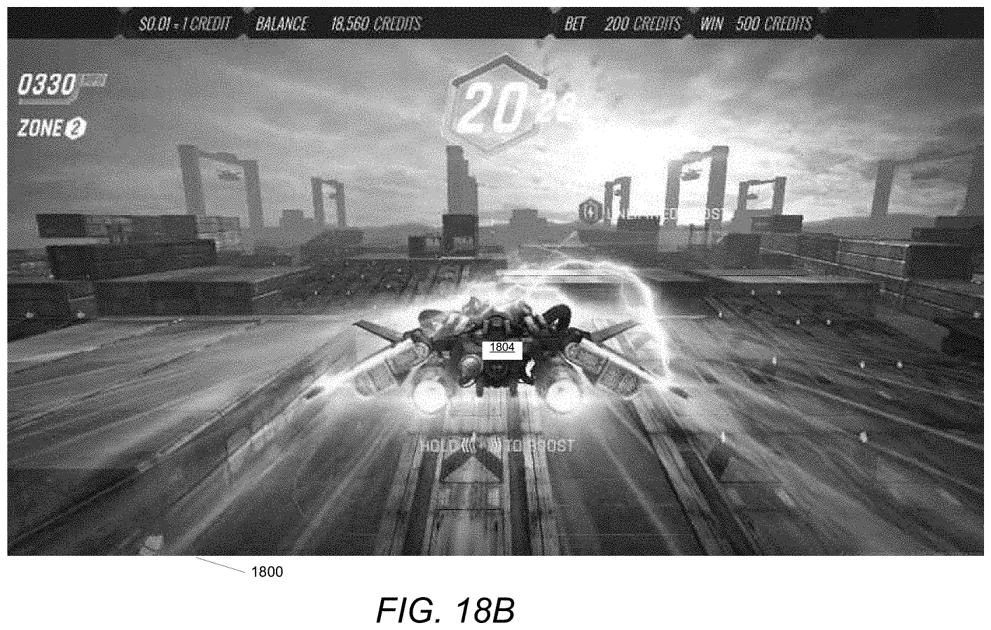

FIGS. 18A and 18B illustrate a user interface 1800 of another interactive skill-based interactive game of a skill compensated interactive wagering system in accordance with an embodiment of the invention. The skill-based interactive game is a 3rd person perspective three-dimensional infinite runner style game wherein a player guides a virtual vehicle 1804 through a collection of virtual obstacles of a level or game map of the skill-based interactive game. The system utilizes a parlay wagering system wherein each wager is associated with a level of the skill-based interactive game as indicated by level indicators 1802a to 1802e. An objective of the skill-based interactive game is for the player to navigate the virtual vehicle around the virtual obstacles and reach a virtual distance within a specified amount of time. If the player achieves the objective, then the player is awarded a specified amount of credits. The difficulty of the objective is randomly determined using a stochastic element to determine the virtual distance that the player must achieve. That is, the more difficult the level, the longer the virtual distance the player must travel. If the player fails to navigate a level with a virtual distance that should be easily achieved, the amount of credits that the player was to be awarded is allocated to an unearned win accumulator and awarded to the player as described herein.

In an embodiment, each subsequent parlay wager requires a commitment of an amount of credits greater than an amount of credits committed in the previous parlay wager. In some such embodiments, the amount of credits required to be committed for a subsequent parlay wager is equal to or greater than the amount of credits won in a previous parlay wager. In several embodiments, an amount of credits required to be committed for a subsequent parlay wager is equal to 10% more than an amount of credits won in the previous parlay wager.

In another embodiment, the system utilizes a parlay wagering system wherein each wager is associated with a level of the skill-based interactive game. An objective of the skill-based interactive game is for the player to navigate the virtual vehicle around the virtual obstacles and reach a virtual distance within a specified amount of time. If the player achieves the objective, then the player is awarded a specified amount of credits. The difficulty of the objective is randomly determined using a stochastic element to determine the virtual distance that the player must achieve. That is, the more difficult the level, the longer the virtual distance the player must travel. If the player fails to navigate a level with a virtual distance that should be easily achieved, the amount of credits that the player was to be awarded is allocated to an unearned win accumulator and awarded to the player as described herein.

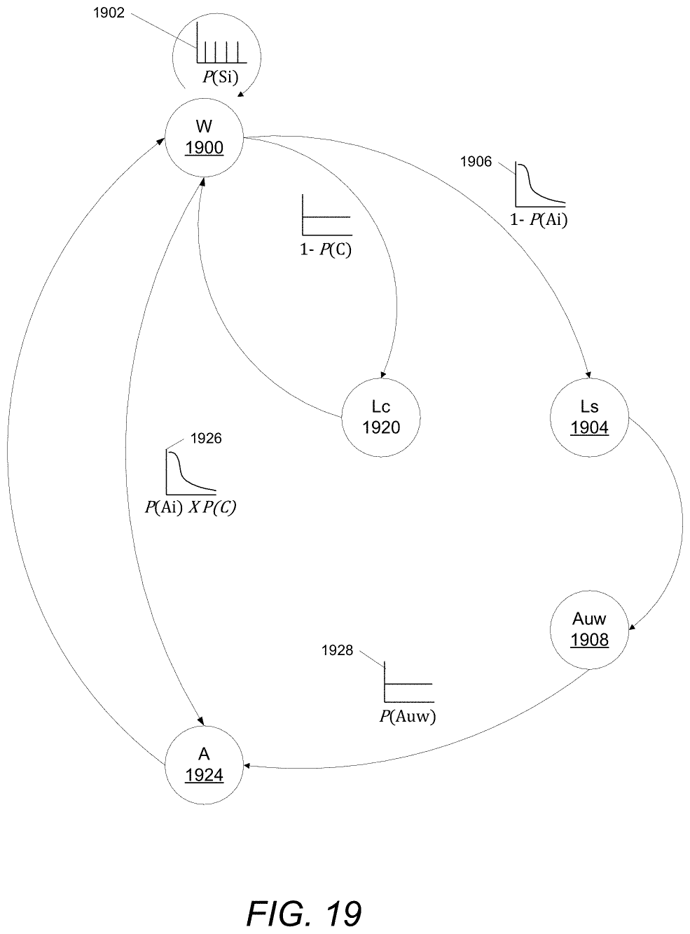

FIG. 19 is a state diagram of a process of a skill compensated interactive wagering system in accordance with various embodiments of the invention. During an interactive wagering process, the system executes a sequence of wagers. Each wager is initiated by the system detecting a player attempting to select a virtual target object of a user interface. In response to detecting an attempt at selecting the virtual target object, the system commits a wager of an amount of credits to the wager. However, if the system detects that the player attempts to select the virtual target object and determines that the player misses the selection thus failing to achieve the objective, no wager is executed even though an amount of credits were committed to a wager and the system allocates any such credits to an unearned win accumulator. If the system determines that the player successfully selects a virtual target object thus successfully achieving the objective, the system executes the wager and the system generates a stochastic element that is used in conjunction with a paytable to determine an interactive wagering outcome of an amount of credits that are awarded to the player. The system awards credits from the unearned win accumulator randomly to the player.

Turning to FIG. 19, during the wagering sequence an amount of credits are committed to the wager by the system while in state W 1900. The wager commitment is detected by the system as a player attempt at a selection of a virtual target object having a probability of P(Si) 1902. If the player makes a selection but misses the virtual target object thus failing to achieve the objective, the system transitions to skill loss state Ls 1904 with a probability of 1−P(Ai) 1906. In skill loss state Ls 1904, the system transitions to an unearned win state Auw 1908, and allocates an amount of credits to an unearned win accumulator. The amount of credits allocated is an amount of credits that the player committed to the wager.

If the system determines that the player successfully selects the virtual target object thus achieving the objective, a the system executes a wager by generating a stochastic element and using a paytable to determine a chance-based outcome for the interactive wager. If the system determines that the chance-based outcome is a loss for the player, then the system transitions to a chance-based loss state LC 1920 with a probability of 1−P(C) 1922. The system transitions back to the wager state W 1900 so the player may make additional wagers.

If the system determines that the chance-based outcome is a win for the player the system transitions to an award state A 1924 with a probability of P(A)×P(C) 1926. In state A 1924 the system awards the player a chance-based outcome of an amount of credits.

In addition to the award for achieving the final objective, the system may award the player a bonus award of an amount of credits from the unearned win accumulator. Whether or not to award the player from the unearned win accumulator is determined by the system by generating a stochastic element and the system transitions from the award accumulator state Auw 1908 to the award state A with a probability of P(Auw) 1928.

In some embodiments, the system allocates to each virtual target object an amount of hit points and a specified award value of credits. Each time the system detects that the player successfully interacts with a virtual target object, the system generates a stochastic element and deducts an amount of hit points from the virtual target object based on the stochastic element. When the system determines that all of the hit points have been deducted from the virtual target object, the system awards to the player the specified award value of credits.

In some embodiments, the system allocates to each virtual target object an amount of hit points. Each time the system detects that the player successfully interacts with a virtual target object, the system generates a stochastic element and deducts a random number of hit points from the virtual target object based on the stochastic element. When the system determines that all of the hit points have been deducted from the virtual target object, the system generates a stochastic element and uses the stochastic element and a paytable to determine an award value of a random amount of credits awarded to the player.

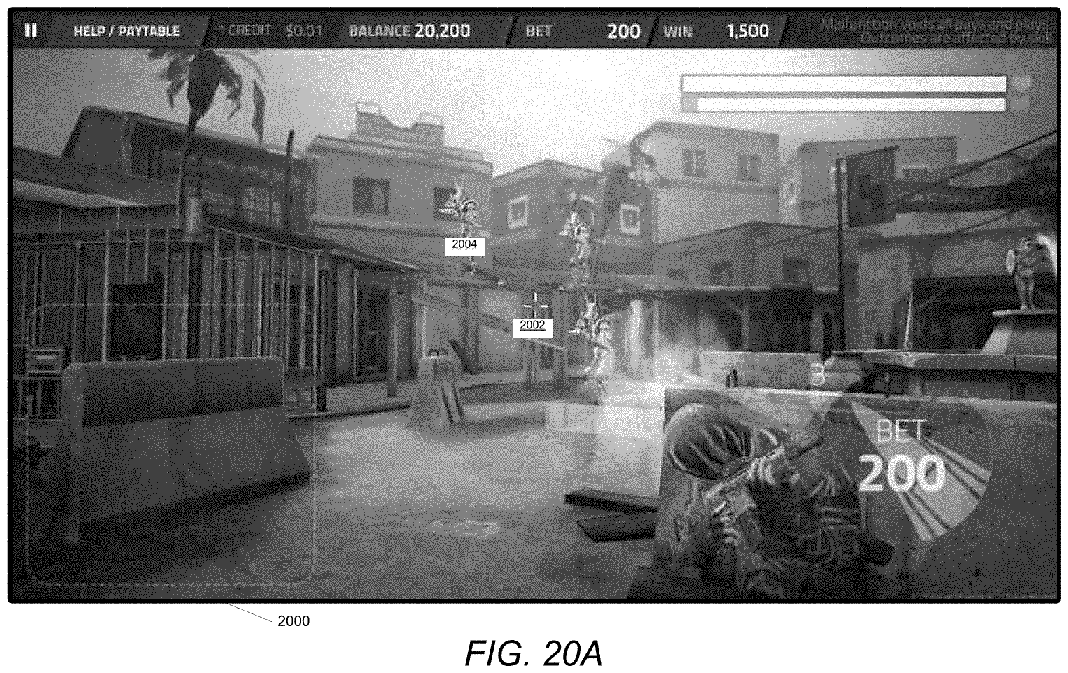

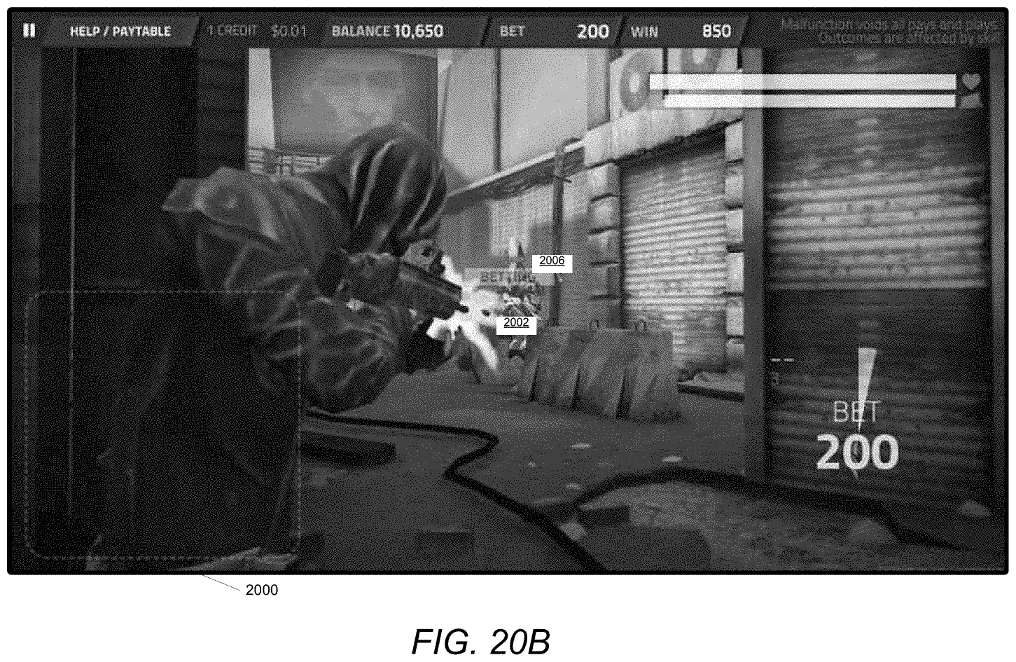

FIGS. 20A and 20B illustrate a user interface 2000 of another interactive skill-based game of a skill compensated interactive wagering system in accordance with an embodiment of the invention. The skill-based interactive game is a 3rd person perspective three-dimensional shooter style game wherein a player attempts to shoot virtual target objects with a virtual gun. The player aligns a virtual reticle 2002 over a virtual target object in order to select the virtual target object, such as target 2004. Each time the player attempts to shoot a virtual target object, a commitment of an amount of credits is made 2006. If the system detects that the player misses the virtual target object, no wager is executed and the amount of credits that the player committed is allocated to an unearned win accumulator. Amounts of credits from the unearned win accumulator are periodically awarded to the player as described herein.

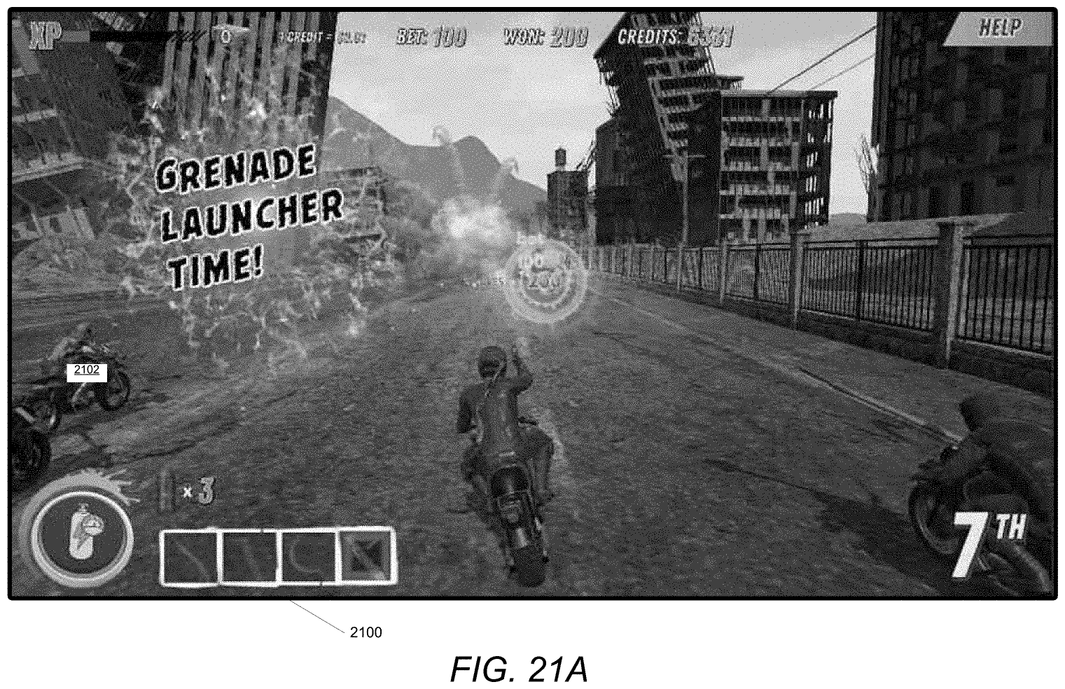

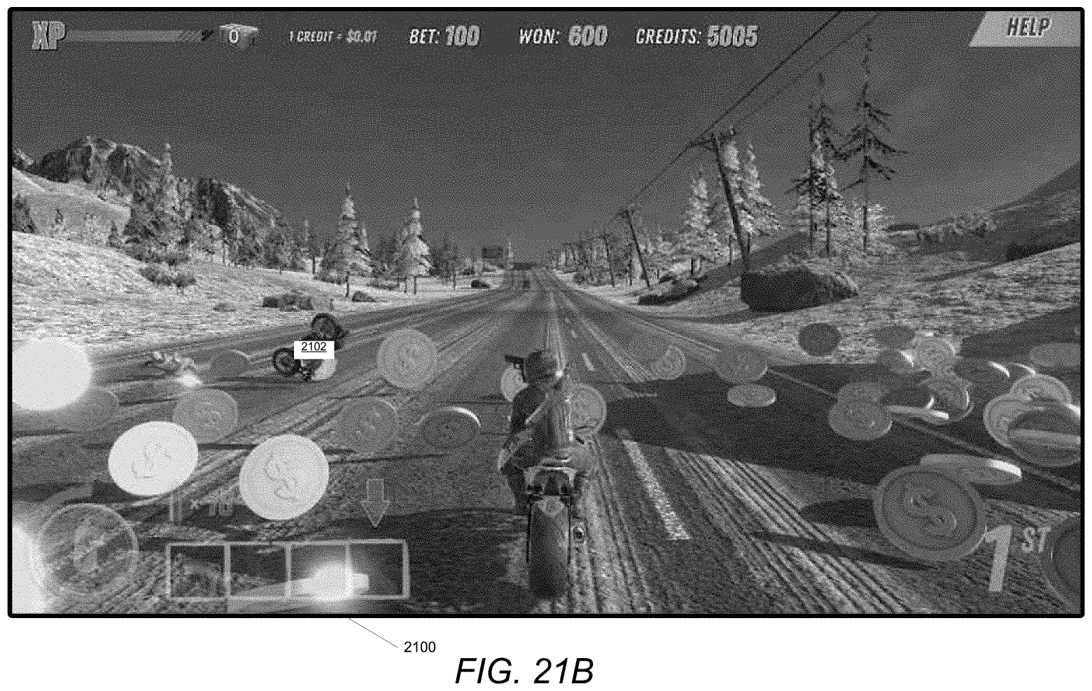

FIGS. 21A and 21B illustrate a user interface 2100 of another interactive skill-based game of a skill compensated interactive wagering system in accordance with an embodiment of the invention. The skill-based interactive game is a 3rd person perspective three-dimensional shooter style game wherein a player attempts to engage virtual target objects, such as virtual target object 2102 with a variety of virtual weapons by selecting the virtual target objects on a touch screen. Each time the system detects that a player selects a virtual target object, a commitment of an amount of credits is made. If the system detects that the player misses the virtual target object, no wager is executed and the amount of credits that the player committed is allocated to an unearned win accumulator. Amounts of credits from the unearned win accumulator are periodically awarded to the player as described herein.

In an embodiment, an interactive wagering game includes matching symbols in the form of bottle caps. A player achieves matches to earn selections in an outcome selector as described herein. If the player is unable to make enough matches to earn all of the available selections, unearned wins are accumulated in an unearned win accumulator based on a difference between an expected value when the player has earned all of the available selections and an expected value when the player has earned less than all of the available selections.

In another embodiment, an interactive wagering game includes a third person perspective infinite runner game where a player attempts to avoid zombies and collect objects as an achievement of an objective. A player achieves collecting objects to earn selections in an outcome selector as described herein. If the player is unable to collect enough objects to earn all of the available selections, unearned wins are accumulated in an unearned win accumulator based on a difference between an expected value when the player has earned all of the available selections and an expected value when the player has earned less than all of the available selections.

While the above description may include many specific embodiments of the invention, these should not be construed as limitations on the scope of the invention, but rather as examples of embodiments thereof. It is therefore to be understood that the invention can be practiced otherwise than specifically described, without departing from the scope and spirit of the invention. Thus, embodiments of the invention described herein should be considered in all respects as illustrative and not restrictive.

What is claimed:

1. An electronic gaming machine for skill compensated interactive wagering, comprising:
an interactive controller constructed to:
generate an interactive user interface including interactive elements;
detect player interactions of a player with the interactive user interface;
detect a wager commitment based on the player interactions;
determine a skill-based objective achievement state based on the player interactions; and
communicate data of the wager commitment and the skill-based achievement state to the a process controller; and
the process controller operatively connected to the interactive controller, wherein the process controller includes a random number generator, and wherein the process controller is constructed to:
receive the data of the wager commitment and skill-based objective achievement state from the interactive controller;
in a case the skill-based objective achievement state indicates achievement of a skill-based objective, execute a wager and determine a wagering outcome for the wager using the random number generator; and
in a case the skill-based objective achievement state indicates failure by the player in achieving the skill-based objective, allocate an amount of credits to an unearned win accumulator.

2. The electronic gaming machine for skill compensated interactive wagering of claim 1, wherein the interactive controller and the process controller are constructed from the same device.

3. The electronic gaming machine for skill compensated interactive wagering of claim 1, wherein the process controller is operatively connected to the interactive controller using a communication link.

4. The electronic gaming machine for skill compensated interactive wagering of claim 1, wherein a credit processing subcontroller and the process controller are constructed from the same device.

5. The electronic gaming machine for skill compensated interactive wagering of claim 1, wherein a credit processing subcontroller, the interactive controller, and the process controller are constructed from the same device.

6. The electronic gaming machine for skill compensated interactive wagering of claim 1, further comprising:
a credit processing subcontroller; and
an enclosure constructed to mount:
a user input device operatively connected to the interactive controller;
a user output device operatively connected to the interactive controller;
a credit input device operatively connected to the credit processing subcontroller; and
a credit output device operatively connected to the credit processing subcontroller

7. The electronic gaming machine for skill compensated interactive wagering of claim 6, wherein the process controller is further constructed to:
communicate with the credit input device to receive a credit input;
credit a credit meter with credits based on the incoming credit data;
update the credit meter based on the wagering outcome; and
communicate with the credit output device to generate a credit output based on credits transferred off of the credit meter.

8. An electronic gaming machine for skill compensated interactive wagering, comprising:
an enclosure constructed to mount:
a user input device;
a user output device;
a credit input device; and
a credit output device;
a random number generator; and
at least one processor operatively connected to the user input device, the user output device, the credit input device, and the credit output device; and
a memory operatively connected to the at least one processor, the memory storing processor executable instructions that when executed by the processor cause the processor to:
communicate with the credit input device to receive a credit input;
credit a credit meter with credits based on the credit data;
generate an interactive user interface including interactive elements;
detect player interactions of a player with the interactive user interface;
detect a wager commitment based on the player interactions;
determine a skill-based objective achievement state based on the player interactions;
in a case the skill-based objective achievement state indicates achievement of a skill-based objective, execute a wager and determine a wagering outcome for the wager;
in a case the skill-based objective achievement state indicates failure by the player in achieving the skill-based objective, allocate an amount of credits to an unearned win accumulator.
update the credit meter based on the wagering outcome; and
communicate with the credit output device to generate a credit output based on credits transferred off of the credit meter.
